(19) United States
(12) Patent Application Publication
(10) Pub. No.: US 2024/0289821 A1
(43) Pub. Date: Aug. 29, 2024

(54) SYSTEMS AND METHODS FOR AUTOMATED DIGITAL MARKETING ANALYTICS

(71) Applicant: Clickvoyant, San Diego, CA (US)

(72) Inventor: Kathryn Bartkiewicz, San Diego, CA (US)

(21) Appl. No.: 18/176,276

(22) Filed: Feb. 28, 2023

(51) Int. Cl. G06Q 30/0202; G06Q 30/0242

(52) U.S. Cl. CPC G06Q 30/0202; G06Q 30/0244

(57) ABSTRACT

Methods and systems are provided for automated generation of marketing insights based on digital data collected from a variety of sources. In one example, an analytics platform for providing automated digital marketing analysis comprises an automated insight generation system configured to analyze digital marketing data collected from a plurality of data sources, and based on the analyzed data, generate a visual presentation of an actionable marketing insight, the actionable marketing insight including at least a recommended action, elements of the analyzed data supporting the recommended action, a visual graphic summarizing the elements, and an estimated value to a user of the analytics platform of performing the recommended action; the visual presentation viewable while unconnected to the analytics platform.

### TECHNICAL FIELD

Embodiments of the subject matter disclosed herein relate to digital marketing, and in particular, to an automated process for interpreting marketing data.

### BACKGROUND

Various digital platforms provide business and marketing insights to companies that rely on online sales and/or lead generation, by analyzing digital marketing data and web traffic data received from one or more third party web platforms or services. The third-party web platforms include analytics services, ecommerce platforms, customer relationship management (CRM) platforms or tools, web marketing platforms, and so on (e.g., Google Analytics, Hubspot, Shopify, Salesforce, etc.) Typically, analytics products and services can provide visualizations and/or summaries of digital marketing data and web traffic data to aid customers in increasing online sales. The products and services may display the data on one or more dashboard-type displays, where a customer accesses the dashboard, visually parses and considers a relative importance of various elements of the data, selects control elements to drill down and obtain additional information, and ultimately interprets the data to inform business decisions.

However, the dashboard layouts may not facilitate high-quality decision-making, where a user can easily determine where specific problems exist and how they might be addressed or resolved. Data presented in the dashboards may be difficult to interpret for a person not skilled in data analysis. The data presented in the dashboards may be siloed, where metrics that are displayed together in a dashboard may not be informed by each other. Because the amount of data presented to the customer may be high, and because of the complexity and interrelatedness of the data, interpreting the data may be difficult and may take time. As a result, a manager at a client company may rely on analysts skilled in digital marketing and data analysis to provide actionable insights. Accurately interpreting the data may depend on a skill of the analysts, which may vary between individual analysts, introducing inconsistencies and increasing margins of error with respect to marketing decisions. Relying on the analysts may increase a cost of the analyzing digital marketing data. Additionally, an amount of time spent by the analysts interpreting the digital marketing data may be high, which may impose delays in generating actionable insights resulting in missed opportunities.

### SUMMARY

The current disclosure at least partially addresses one or more of the above identified issues via an analytics platform for providing automated digital marketing analysis comprises an automated insight generation system configured to collect digital marketing data from one or more data sources identified by a first user; analyze the digital marketing data; generate one or more actionable marketing insights based upon the analyzed digital marketing data; generate a visual presentation of the one or more generated actionable marketing insights, the visual presentation comprising at least one recommended action, one or more elements of the analyzed digital marketing data providing support for the at least one recommended action, a visualization summarizing the one or more elements, and an estimated value to the user of performing the at least one recommended action; and providing the visual presentation of the one or more generated actionable marketing insights to the user such that the user can access the visual presentation while the analytics platform is in an unlaunched state.

The analysis of the digital marketing data collected from the plurality of sources may be performed in a cascading manner, where rather than generating and analyzing large, comprehensive datasets, smaller analyses may be performed in a sequence, where a result of a first analysis of data from a first data source may be used in a second analysis of data from a second data source; a result of the second analysis may be used in a third analysis of data from a third data source; and so on. As a result, insights may be generated from data collected across different platforms faster, more efficiently, and at a lower cost than would be entailed by creating and analyzing a large dataset, which may rely on more human expertise and computationally intensive processes. Additionally, the digital marketing data may not be stored on the analytics platform after the actionable marketing insights are generated, reducing a cost of the analytics platform and increasing a security of data owned and maintained by the client company. The visual presentations may be personalized to the user, and presented in a manner that is easy for a person unskilled in data analysis to understand, based on information provided by the user via a graphical user interface of the analytics platform.

In this way, the analytics platform does not rely on the user to interpret a large amount of digital marketing data. Rather, concrete, actionable insights are generated from the digital marketing data using various techniques and models, and pre-packaged for a viewer to view in a manner that is easy to understand and that does not demand interpretation. The viewer may be the user, or the viewer may be another individual, such as a co-worker or manager of the user. For example, the insights may be presented to the viewer as a set of slides following a problem/solution format, where for each slide, a single issue detected during the analysis is communicated, and a specific recommendation to address the issue may be proposed. The slide may include relevant data, graphics, images, and/or other visual elements, in a compact, focused presentation designed not to overwhelm the viewer.

For example, a marketing professional may use the analytics platform to generate a plurality of slides, each slide including a marketing insight relevant to a client company of the marketing professional. The marketing professional may specify a plurality of data sources to be used by the platform in the analysis and a goal. For example, the goal may be to increase a number of leads generated from organic search results of a search engine, where the organic search results link to a website of the client company. The slides may be viewed by the marketing professional in a slideshow application chosen by the marketing professional. The marketing professional may edit and/or use the slides to generate a proposal for improving lead generation for the client company. Additionally or alternatively, the marketing professional may provide the slides directly to a manager of the client company. The manager may review the slides, prioritize them based on the issues presented, edit relevant slides, and present the relevant slides to a decision-maker at the client company. In this way, decision-making with respect to a web marketing strategy may be performed more quickly and easily than with other approaches that rely on analyzing large amounts of data organized in a dashboard, which may be tedious and time consuming. Typically an analyst would then have to synthesize and reformat the data from the dashboard into a presentation that can be easily consumed by stakeholders. An additional advantage of using the analytics platform to generate slides with marketing insights is that, in contrast to alternative analytics implementations, skilled data analysts may not be relied on, reducing an operational cost of interpreting the digital marketing data.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 is a schematic block diagram of a digital marketing ecosystem, in accordance with one or more embodiments of the present disclosure;

FIG. 2 is a schematic block diagram of an analytics platform operating within the digital marketing ecosystem, in accordance with one or more embodiments of the present disclosure;

FIG. 3 is a schematic block diagram showing an overview of a process for generating marketing insights, in accordance with one or more embodiments of the present disclosure;

FIG. 4A is a flowchart illustrating an exemplary method for generating marketing insights from digital marketing data, in accordance with one or more embodiments of the present disclosure;

FIG. 4B is a flowchart illustrating an exemplary method for auditing data sources, in accordance with one or more embodiments of the present disclosure;

FIG. 4C is a flowchart illustrating an exemplary method for creating a customized visualization of a marketing insight, in accordance with one or more embodiments of the present disclosure;

FIG. 5 is an exemplary visualization of a result of a data auditing process, in accordance with one or more embodiments of the present disclosure;

FIG. 6A is a first example of a graphical element created to visualize a marketing insight, in accordance with one or more embodiments of the present disclosure;

FIG. 6B is a second example of a graphical element created to visualize a marketing insight, in accordance with one or more embodiments of the present disclosure;

FIG. 6C is an example of a graphical element created to visualize additional information related to a marketing insight, in accordance with one or more embodiments of the present disclosure;

FIG. 7 is an example of metadata in a data-interchange format used by an internal API of an analytics platform, in accordance with one or more embodiments of the present disclosure;

FIG. 8A is an example graphical element indicating a relative weighting of an estimated value to a user of the analytics platform of acting on a marketing insight, in accordance with one or more embodiments of the present disclosure; and

FIG. 8B is an example graphical element indicating scores assigned to parameters of an estimated value to a user of the analytics platform of acting on a marketing insight, in accordance with one or more embodiments of the present disclosure.

### DETAILED DESCRIPTION

The methods and systems described herein relate to an automated process for generating marketing insights from raw digital data collected across various data sources and presenting the marketing insights in an easy-to-digest manner.

For businesses that rely on online sales or lead generation via a company website, various approaches to digital and/or web marketing may boost revenue. The various approaches may include direct email campaigns; placement of advertisements on third party sites, such as search engines (e.g., Google Ads), social media platforms (e.g., Facebook, Instagram), video streaming sites (e.g., YouTube, TikTok), blogging platforms, review sites, and/or other websites; organic search strategies aimed at positioning webpages prominently in search results; internal navigation strategies aimed at funneling potential customers to relevant portions of the company website; and so on. Typically, a primary goal of web marketing is to increase traffic to the company website through well-positioned links in emails and third party sites, often to specific landing pages or other pages of the website designed to increase conversions. Marketing campaigns may vary in complexity, and may include coordinated activities between email, web marketing, and other media, including ad placements with various third party sites.

Web marketing is often carried out in an iterative or cyclical manner. First, an idea for a campaign may be formulated, based on a sales strategy and a target customer, and one or more advertisements may be prepared and placed or emailed out. Second, data may be collected on customer interaction with the website and sales made as a result of the campaign. The data may include, for example, clickthrough rates (CTR); money spent on different advertisements and return on investment (ROI); conversion rates; customer demographics; dates and timing of clicks and sales; amount of time spent on pages of the website; paths taken through the website by potential customers and contributions of various pages towards making a sale; and so on. Third, managers or employees of the company may analyze the data to determine a level of success of the campaign, identify successful and unsuccessful aspects of the campaign, more accurately identify the target customer or groups of target customers, identify areas of improvement, identify things to focus on, identify new directions for honing the sales strategy, and the like. Fourth, the insights gathered from analyzing the data may be used to generate one or more subsequent marketing campaigns. In this way, the company may iteratively refine its online sales strategy and increase revenue over multiple campaigns by more efficiently meeting a market need.

Various companies offer technologies and tools for collecting the data, displaying the data, analyzing the data, and/or managing online marketing campaigns. For example, an online sales platform such as Shopify may collect the data as a service to customers, or the data may be collected by a customer relationship management (CRM) system and/or a third party service such as Google Analytics. The company may also write custom code to collect and/or analyze data. The data may be displayed via a user interface (UI) of the online sales platform or third party service, or a proprietary UI, or the company may use a different tool to display the data collected by the online sales platform or third party service. For example, a company with a WordPress ecommerce site may use MonsterInsights to view data collected by Google Analytics. The tools may display the data in a dashboard or similar set of layouts that may be customized by a manufacturer of the tool and/or by a user. The tools may provide links to additional information, allowing a user to drill down to access more specific information. The tools may also offer various levels of analysis.

To aid a user in interpreting and drawing inferences from the collected data, an analytics platform is described herein that processes the data and offers data-driven marketing insights. The marketing insights may be displayed in an alternative manner (e.g., not via a dashboard) that is more easily interpretable by a user. Additionally, data sets used by the analytics platform may be of a smaller size than other dashboard-based tools, thereby increasing a usefulness of the platform.

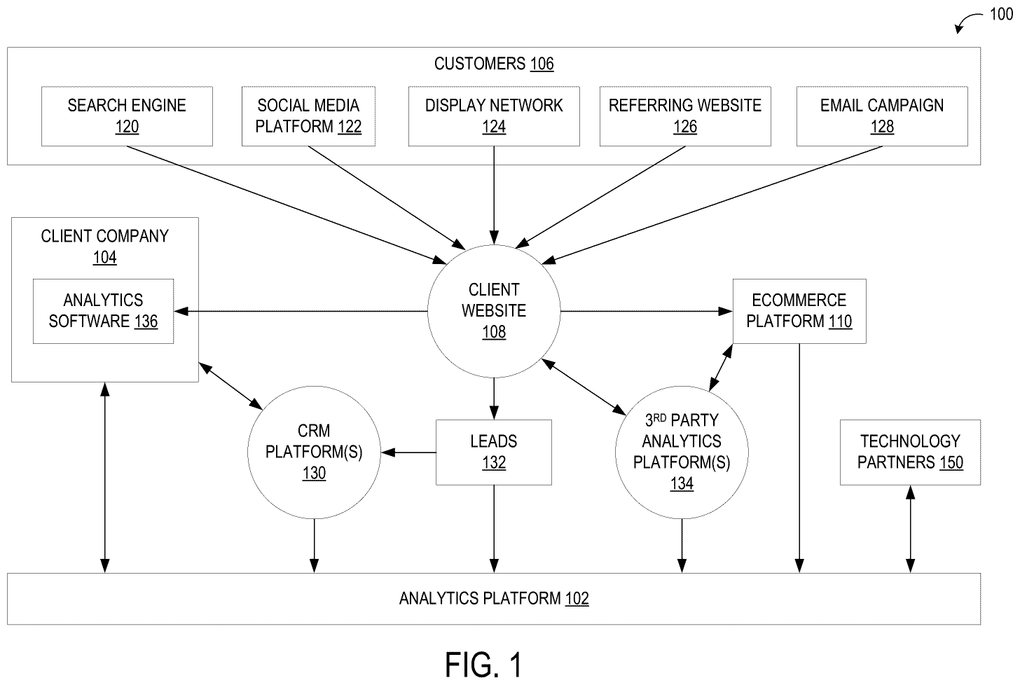

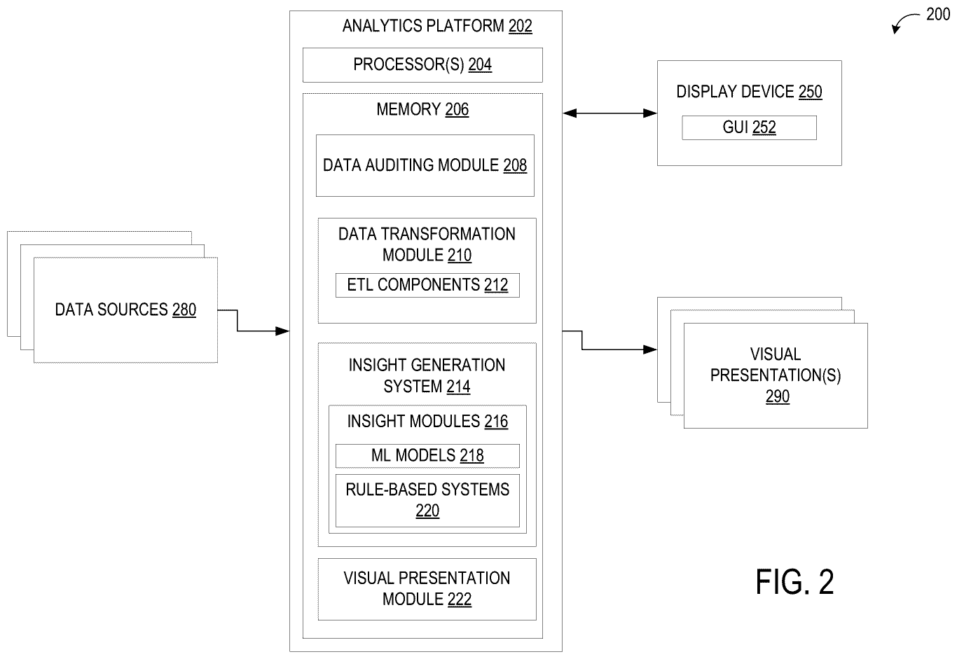

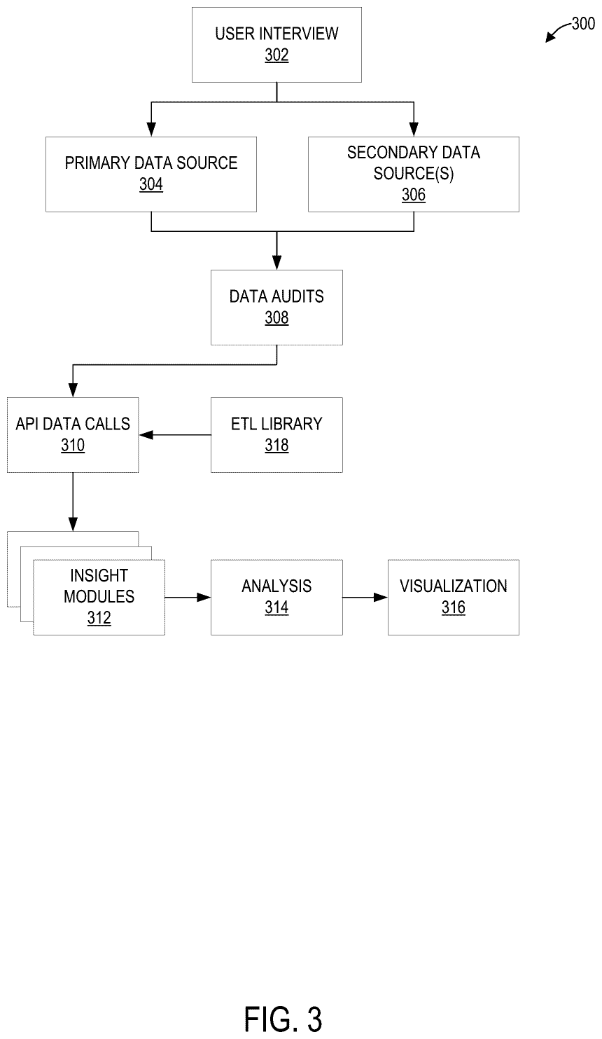

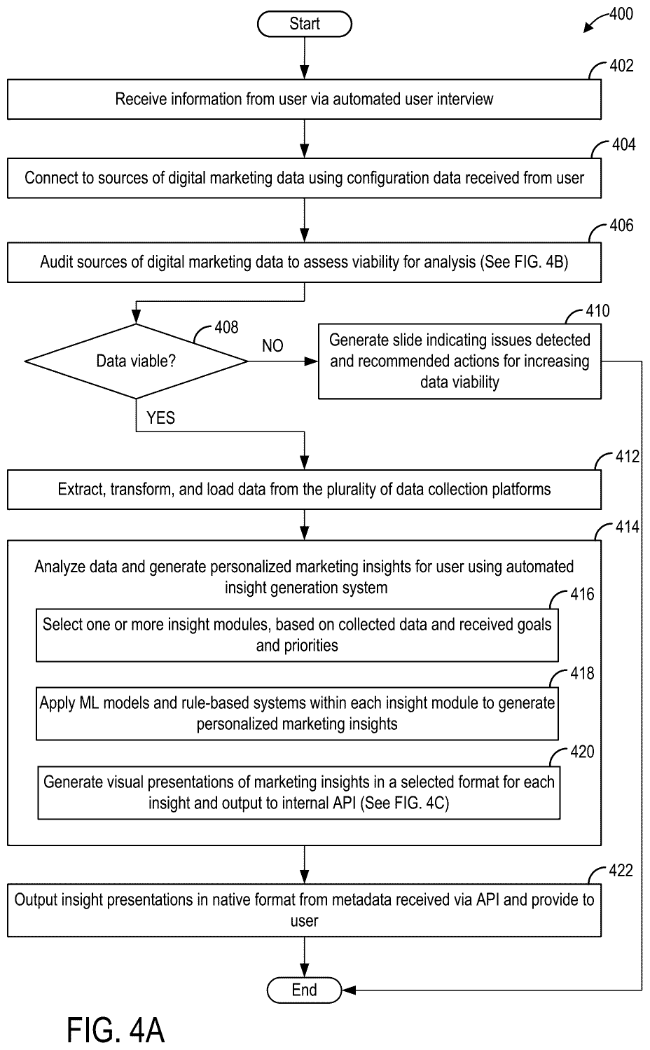

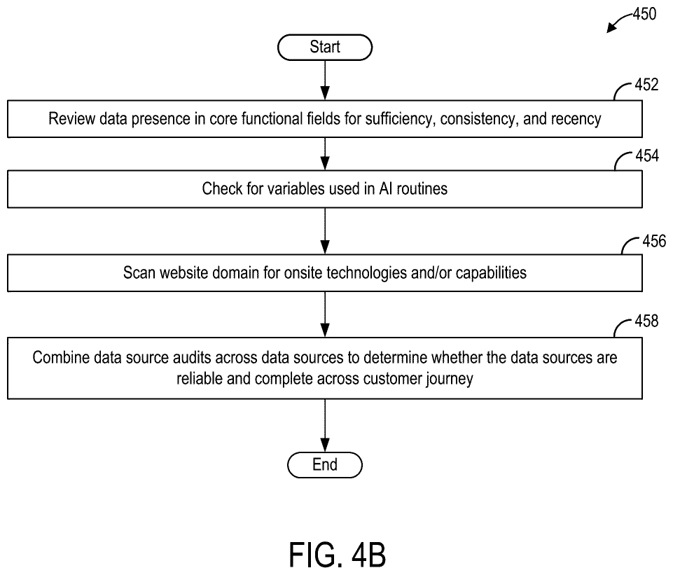

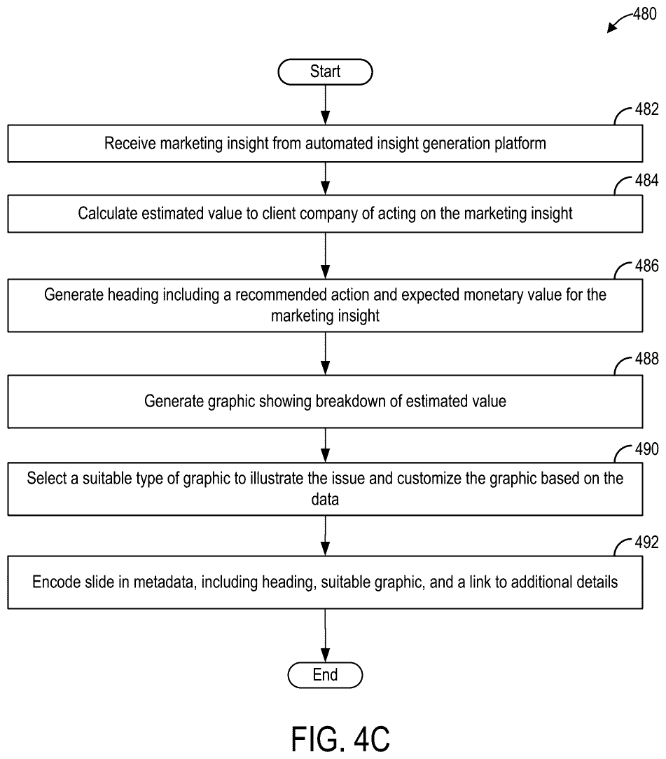

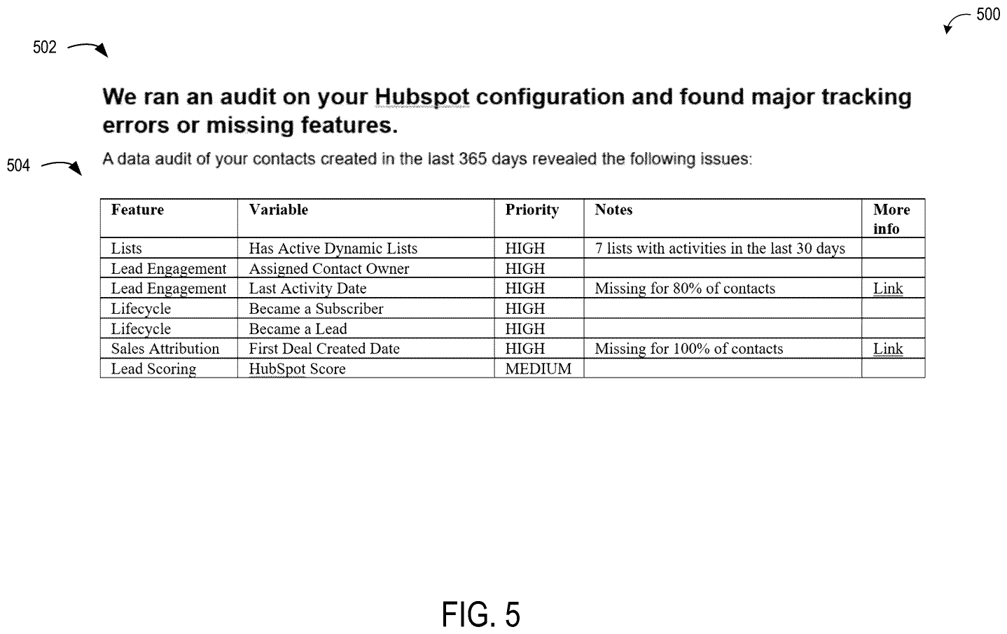

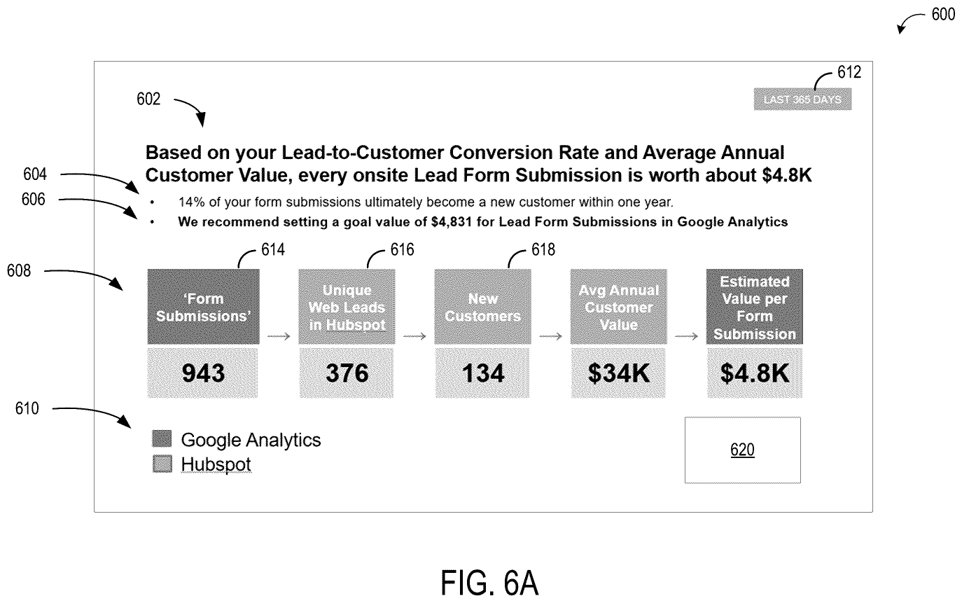

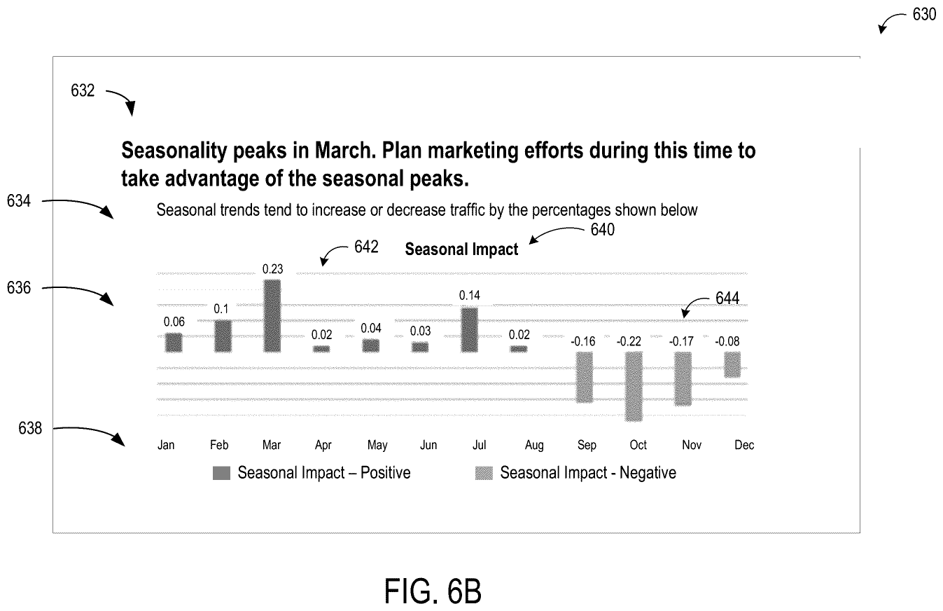

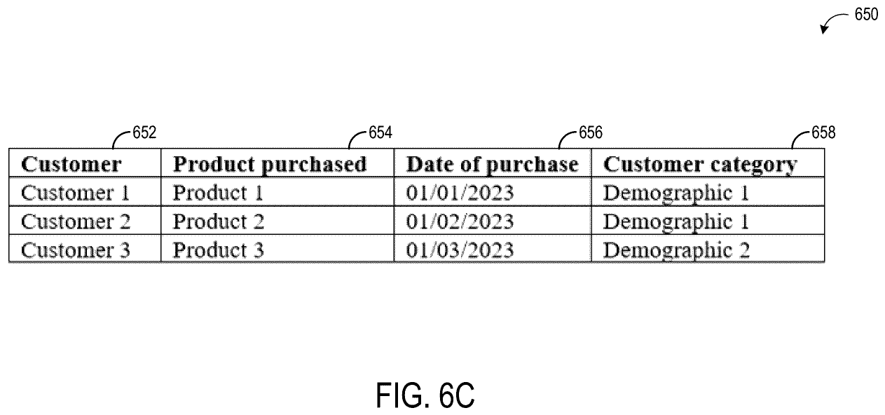

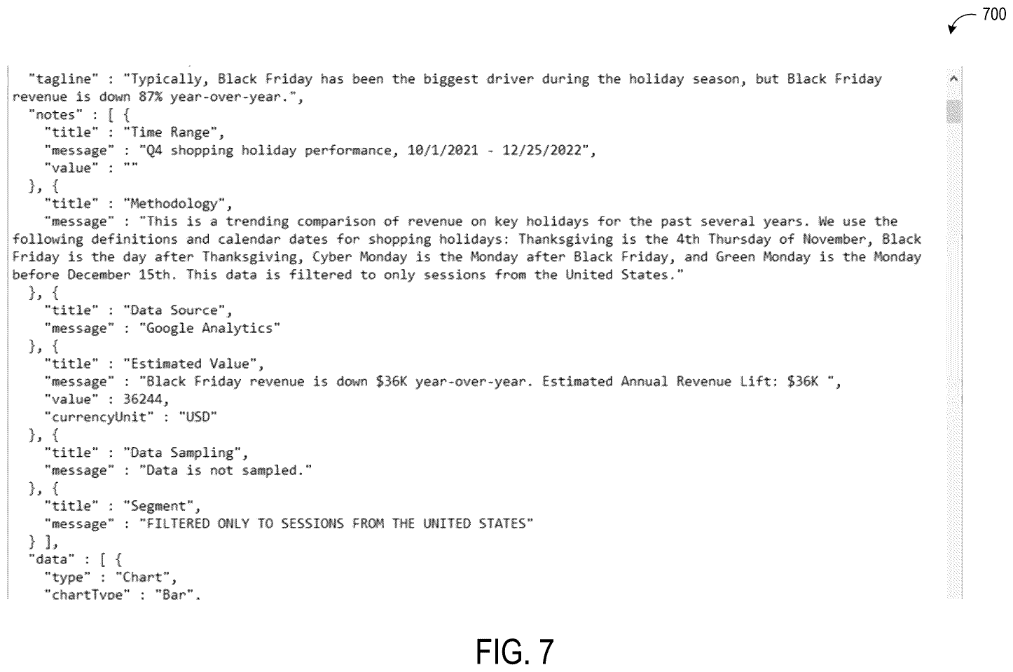

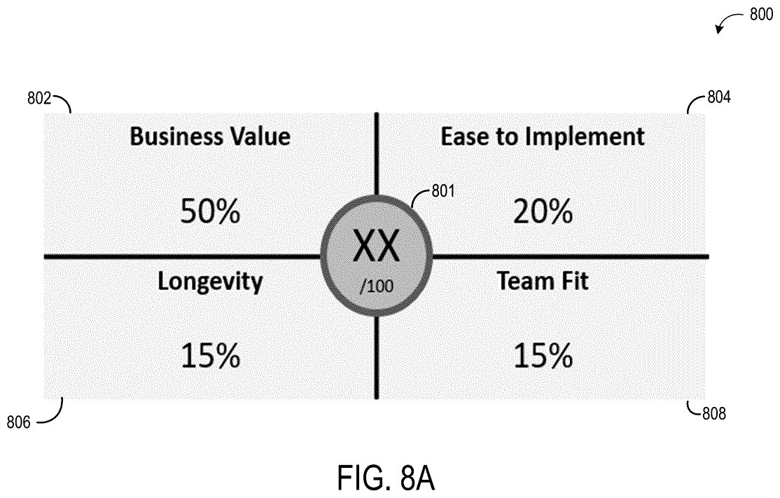

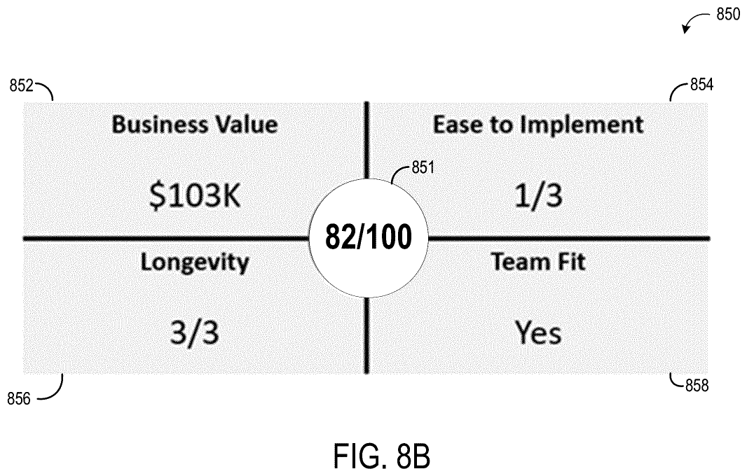

FIG. 1 shows a digital marketing ecosystem, including an analytics platform that analyzes customer and marketing data of a client company received from a website of the client company, and various other sources of digital marketing data. Various components of the analytics platform are shown in FIG. 2, which may analyze the received customer and marketing data to generate one or more visualizations (e.g., slides) including marketing insights, following a general procedure shown in FIG. 3. The marketing insights may be generated by following one or more steps of the method shown in FIG. 4A. Generating the marketing insights may include auditing sources of data, by following one or more steps of the method shown in FIG. 4B, where data viability issues that are detected during the data audits and recommendations for addressing the data viability issues may be presented to the client company in a slide shown in FIG. 5. Generating the marketing insights may include creating visual presentations of the marketing insights, by following one or more steps of the method shown in FIG. 4C. FIGS. 6A and 6B show example visualizations of insights generated by the analytics platform, and FIG. 6C shows an example visualization of details associated with an insight. Data used to generate the visualizations may be transmitted internally between components of the analytics platform in a data-interchange format, as shown in FIG. 7. The visual presentations of the marketing insights may include a graphical display of an estimated value associated with acting on a recommendation included in a marketing insight, as shown in FIG. 8B, which may include parameters that are assigned relative weightings as shown in FIG. 8A.

Referring to FIG. 1, a digital marketing ecosystem 100 is shown, including an artificial intelligence (AI) analytics platform 102, a client company 104, which may be a purchaser of services offered via analytics platform 102, and a plurality of customers 106 of client company 104 to whom client company 104 sells its products and/or services. The client company may sell its products and/or services to its customers in various ways, including via a client website 108. In various embodiments, client website 108 may be hosted on an ecommerce platform 110 (e.g., such as Shopify, Oracle NetSuite, BigCommerce, WordPress, etc.). In other embodiments, client website 108 may be hosted by a website hosting service that is not an ecommerce platform, or client website 108 may be hosted by and/or at one or more servers of client company 104. In some examples, client website 108 may be a third-party site hosted on a seller platform (e.g., Amazon Marketplace, Walmart Marketplace, etc.). Further, in other examples, client website 108 may be a web application, such as a mobile app installed on a smart phone. Client company 104 may additionally sell its products and/or services directly to customers 106, for example, via a physical store, by mail order, and/or in another way.

Customers 106 may access client website 108 in various ways. A customer 106 may be directed to client website 108 by clicking a link in an organic search result or an advertisement (also described herein as an ad) of a search engine 120 (e.g., Google, adSense); by clicking a link on a social media platform 122 (e.g., Facebook, Instagram, etc.); by clicking on an ad placed on another website, such as a website of a display network 124; by clicking on an ad placed on a referring website 126, such as a blogging site, consumer review site, and/or a different type of referring website; by clicking on a link embedded in an email sent to a customer, for example, via a direct email campaign 128; and/or by a different method. Thus, increasing online sales and/or lead generation via client website 108 may include attracting an increased number of customers 106 to client website 108. This may be accomplished via various digital marketing strategies, which may be employed individually, jointly, and/or concurrently. The digital marketing strategies may be focused on increasing direct sales (e.g., an ecommerce strategy) and/or generating leads for subsequent sales (e.g., a lead generation strategy).

For example, a first digital marketing strategy (e.g., either a lead generation strategy or an ecommerce strategy) may be to adjust a content or structure of client website 108 in accordance with various search engine optimization (SEO) techniques known in the art in an attempt to increase the number of customers 106 accessing client website 108 by clicking on organic search results generated by search engine 120. A second digital marketing strategy may be to place ads on a social media platform 122, display network 124, and/or referring website 126, or increase an effectiveness of the ads, or adjust a content of the ads to increase a click-through rate (CTR) of the ads. A third digital marketing strategy may be to run or increase an effectiveness of a direct email campaign 128. It should be appreciated that the examples provided herein are for illustrative purposes, and other strategies may be employed.

Increasing sales of the client company's products and/or services online may also include increasing a number of conversions, where a conversion occurs when a customer on the site concludes a sale. Various site organization and internal navigation strategies may be used to direct potential customers to specific pages of client website 108 where a conversion rate is higher, and/or not direct potential customers to pages where the conversion rate is lower. Additionally, conversion rates on low-performing pages may be studied to determine how to increase the conversion rates.

Additionally or alternatively, increasing a number of leads generated via client website 108 may include directing potential customers to specific pages of client website 108 where content is tailored toward getting the potential customers to submit a form or make an inquiry by email or by phone. Form submission rates may be studied to determine how to increase rates on low-performing pages.

Because the success of each strategy is unknown prior to implementation, and because an amount of development time and cost may vary across strategies, selecting an optimal strategy or set of strategies to increase sales may be challenging. To aid in the selection of the optimal strategy or set of strategies, managers or analysts of client company 104 may analyze digital marketing data, including web traffic data, customer relationship data, marketing data resulting from previous marketing campaigns, and other data. The data may be collected by ecommerce platform 110, or a web hosting company, or the data may be collected by one or more third party data collection and/or analysis services. For the purposes of this disclosure, digital marketing data refers to digital data relating to customers 106 and/or usage of client website 108 from which marketing insights can be generated.

The one or more third party data collection and/or analysis services may include one or more customer relationship management (CRM) platforms 130, which may be used by client company 104 to collect data of customers 106 and manage sales relationships with customers 106. The one or more third party data collection and/or analysis services may also include one or more third party analytics platforms 134, such as, for example, Google Analytics. analytics platforms 134 may be configured to collect and/or receive data from client website 108, ecommerce platform 110, and/or other web sources, and may provide client company 104 with access to the data. Client company 104 may access and analyze the data collected from the one or more CRM platforms 130 and the one or more analytics platforms 134 to generate appropriate web marketing strategies. In some cases, the data may be analyzed by data analysts of the client company. For example, the data analysis may view the data on a dashboard generated by an analytics software 136 of client company 104, which may include off-the-shelf software products and/or proprietary software of client company 104.

Within digital marketing ecosystem 100, analytics platform 102 may provide additional marketing and business insights to the client company, as described in greater detail below. analytics platform 102 may receive digital marketing data from one or more third party analytics platforms 134 and/or one or more CRM platforms 130 and apply various AI-based models to the digital marketing data to generate the marketing insights. The marketing insights may subsequently be sent to client company 104. Each marketing insight may indicate a specific issue that impacts online sales or lead generation and provide a specific recommendation for addressing the issue to increase conversions and/or leads. The marketing insights may include an estimate of a value to the client company of addressing the issue. Additionally, analytics platform 102 may provide the marketing insights to the client company based on an integrated and/or collective analysis of digital marketing data received from multiple sources. The integrated and/or collective analysis may increase an amount of digital marketing data used to generate the marketing insights, increasing a quality and/or accuracy of the marketing insights. The integrated and/or collective analysis may also support data triangulation, whereby results of an analysis of a first set of data may be used in an analysis of a second set of data.

For example, a first set of AI analytic methods and/or machine learning (ML) models may be used to perform a first analysis of combined data collected from both a first data source (e.g., Hubspot), and a second data source (e.g., Google Analytics). Additionally or alternatively, a second set of AI analytic methods and/or ML models may be used to perform a second analysis of the first source, and use a result of the second analysis and data from the second source to perform a third analysis; use a result of the third analysis and data of the first source to perform a fourth analysis; use results of the first analysis and the second analysis to perform a fifth analysis; and so on, where data may be analyzed in a chained or cascading fashion. For example, data retrieved from Hubspot (e.g., the first data source) may be used to calculate a dollar value of a form submission on client website 108. The dollar value may be inserted as a monetary goal value in Google Analytics (e.g., the second data source), to generate a marketing insight relating to increasing a number of form submissions, as shown in FIG. 6A and described below. The dollar value could additionally be used to understand a monetary benefit of advertising on a referring website 126 (e.g., a third data source), or calculate a profitability of an ad campaign 128 (e.g., a fourth data source).

Additionally, analytics platform 102 may receive digital marketing data from one or more technology partners 150, which may provide additional services that may be used to increase an effectiveness of analytics platform 102 and/or a quality of the marketing insights generated by analytics platform 102. The additional services may include, for example, eye tracking technologies, where a user's eyes are tracked to determine where the user is looking when viewing data and how the user's eyes move as they process visual information.

The additional services may also include text generation, e.g., the automatic creation of content such as headlines, calls to action (CTAs), and/or body text. For example, a first pass analysis from Google Analytics may identify a blog page that is underperforming in organic search. A copy of the blog page may be fed into a model to identify the key topics of the page, such as OpenAI's ChatGPT. The identified key topics may be fed into a search engine (e.g., Google Search) to identify top-ranking content for the key topics. The top-ranking content may then be fed back into the model to generate a new version of the copy of the page that targets key audiences, for example, that have already been identified in Hubspot. A third tool (e.g., SEOSurfer) may be used to assess an SEO score of the key topics and/or generated content. Iterations may be performed until the SEO score achieves a desired threshold. An end user might see a list of the underperforming blog pages, where the recommended new page copy may be displayed via a user action, such as a double-click.

As another example, a first pass analysis from Google Analytics and Hubspot may identify a high volume landing page that has a conversion rate below a threshold amount of predicted conversions. A set of CTAs on the landing page may be fed into a model such as OpenAI's ChatGPT, to generate a plurality of different versions. For example, three versions may be created. The three versions may be automatically passed to an A/B testing tool (e.g., Google Optimize) to compare a conversion rate performance of the three different CTAs. The end user might view the poorly performing landing pages, where double-clicking a landing page might display a slide with the three alternative CTAs.

Referring to FIG. 2, a proposed analytics system 200 is shown, including an analytics platform 202, which may be a non-limiting example of analytics platform 102 of FIG. 1. As such, analytics platform 202 may take as input web traffic data, lead generation data, and other digital marketing data collected from a plurality of data sources 280, and generate as output (e.g., for a client company such as client company 104) one or more insights in the form of, for example, slides designed to help the client company address specific issues to increase revenue from online sales or achieve other client company goals. The plurality of data sources 280 may include, for example, one or more CRM platforms; one or more external analytics platforms; an ecommerce platform; and/or one or more in-house analytics programs of the client company, such as CRM platform(s) 130, third party analytics platforms 134, ecommerce platform 110, and analytics software 136 described above in relation to FIG. 1, and/or a different type of data source.

analytics platform 202 may be operated or hosted on a computing device, such as a desktop computer (e.g., a PC or a workstation), a server, or different kind of computing device. analytics platform 202 may include a processor 204 and a memory 206. Processor 204 may control an operation of analytics platform 202 in response to control signals received via a GUI 252, which may be displayed on a display device 250 electronically coupled to analytics platform 202. Specifically, a user may interact with, adjust, or select control elements in GUI 252 via display device 250, such as with a mouse, track ball, touchpad, etc., or the operator may interact with GUI 252 via a touchscreen, where the operator touches a display screen of GUI 252 to interact with GUI 252, or via another type of input device. In various embodiments, GUI 252 is displayed via an Internet browser, or via an application installed on a computer of a user of analytics platform 202.

Processor 204 may execute instructions stored on the memory 206 to control analytics platform 202. Processor 204 may be single core or multi-core, and the programs executed thereon may be configured for parallel or distributed processing. In some embodiments, the processor 204 may optionally include individual components that are distributed throughout two or more devices, which may be remotely located and/or configured for coordinated processing. In some embodiments, one or more aspects of the processor 204 may be virtualized and executed by remotely-accessible networked computing devices configured in a cloud computing configuration.

As discussed herein, memory 206 may include any non-transitory computer readable medium in which programming instructions are stored. For the purposes of this disclosure, the term “tangible computer readable medium” is expressly defined to include any type of computer readable storage. The example methods and systems may be implemented using coded instruction (e.g., computer readable instructions) stored on a non-transitory computer readable medium such as a flash memory, a read-only memory (ROM), a random-access memory (RAM), a cache, or any other storage media in which information is stored for any duration (e.g. for extended period time periods, permanently, brief instances, for temporarily buffering, and/or for caching of the information). In some embodiments, the non-transitory computer readable medium may be distributed across various computers and/or servers (e.g., provided via web services). Computer memory of computer readable storage mediums as referenced herein may include volatile and non-volatile or removable and non-removable media for a storage of electronic-formatted information such as computer readable program instructions or modules of computer readable program instructions, data, etc. that may be stand-alone or as part of a computing device. Examples of computer memory may include any other medium which can be used to store the desired electronic format of information and which can be accessed by the processor or processors or at least a portion of a computing device. In various embodiments, memory 206 may include an SD memory card, an internal and/or external hard disk, USB memory device, or similar modular memory.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present disclosure may be written in any combination of one or more programming languages, markup languages, and/or frameworks, including an object-oriented programming language such as Java, Smalltalk, C++ or the like; conventional procedural programming languages, such as the “C” programming language or similar programming languages; and web programming languages or frameworks such as ReactJS, HTML, and CSS. It should be appreciated that the examples provided herein are for illustrative purposes, and other languages or frameworks may be used without departing from the scope of this disclosure. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Memory 206 may include various modules comprising instructions for generating and presenting marketing insights, as disclosed herein. Memory 206 may include a data auditing module 208, which may include instructions for performing one or more data audits on data received at analytics platform 202. During a data audit, a viability of digital marketing data available to or collected by analytics platform 202 may be assessed. If the digital marketing data is determined not to be viable (e.g., insufficient, inaccurate, duplicated, etc.), data auditing module 208 may generate one or more recommendations for increasing the viability of the digital marketing data. For example, a configuration of one or more of data sources may be adjusted to increase an amount of data collected from the one or more data sources. Auditing the digital marketing data collected from or available at a data source is described in greater detail below in relation to FIG. 4A.

Memory 206 may include a data transformation module 210, which may include instructions for extracting, cleaning, curating, and/or transforming the data accessed at the plurality of data sources. Transforming the data may include removing elements of data, adjusting case and/or punctuation, normalizing and/or standardizing data collected from different sources, or other transformations. To perform the data transformations, the data transformation module may further include a library of extract, transform, and load (ETL) components 212, which may be selected based on specific transformation tasks. For example, a first ETL component 212 may be selected to perform a first extraction task; a second ETL component 212 may be selected to perform a second cleaning task; a third ETL component 212 may be selected to perform a third homogenization task; and so on. Data transformation is described in greater detail below in reference to FIG. 4A.

Memory 206 may include an insight generation system 214 including instructions for generating marketing insights, which may identify issues detected in the data that impact sales or lead generation and present recommendations for addressing the issues to increase the sales or leads generated. Insight generation system 214 may include one or more insight modules 216, where each insight module 216 may be used to generate a specific type of insight. For example, a first insight module 216 may be used by insight generation system 214 to generate an insight relating to form submission; a second insight module 216 may be used by insight generation system 214 to generate an insight relating to increasing conversions from customers (e.g., customers 106) linking to a client website (e.g., client website 108) from an email campaign; a third insight module 216 may be used by insight generation system 214 to generate an insight relating to increasing conversions from customers linking to the client website from a social media platform (e.g., social media platform 122); and so forth.

An insight module 216 may include one or more ML models 218 and one or more rule-based systems 220, which may be used to generate insights from the collected digital marketing data. For example, an ML model 218 may be trained on ground truth digital marketing data collected from a plurality of client companies, and the trained ML model 218 may take new digital marketing data from a new client company as input and output a predicted monetary value of following a recommendation proposed in the insight.

Memory 206 may include a visual presentation module 222, which may generate a plurality of visual presentations 290 of a corresponding plurality of marketing insights generated by insight generation system 214. Specifically, visual presentation module 222 may store instructions for generating a customized visual presentation 290 for each marketing insight (also referred to herein as a slide) and packaging the slides into a compilation of insights (e.g., a slideshow). In various embodiments, the insights may be encoded as metadata in a data-interchange format and exported via an internal application programming interface (API) to generate a platform-independent implementation of the compilation of marketing insights that may be opened in a variety of different native applications (e.g., a slideshow application, a text document, etc.). The data transformation, auditing, and insight generation processes are described in greater detail below in reference to FIGS. 3, 4A, and 4B.

FIG. 3 shows a simplified overview of a process 300 for generating insights using an analytics platform, such as analytics platform 102 of FIG. 1 and/or analytics platform 202 of FIG. 2. In various embodiments, process 300 begins with an automated user interview 302, which may be performed with a user of the analytics platform via a GUI of the analytics platform (e.g., GUI 252 of FIG. 2). During the automated user interview 302, a user may define a primary data source 304, and one or more secondary data sources 306. Some types of data sources may be particularly relevant to an ecommerce strategy, while other types of data sources may be particularly relevant to a lead generation strategy, or a content generation strategy, or a different kind of strategy. Prior to extracting data from primary data source 304 and/or secondary data sources 306, one or more data audits 308 may be performed on primary data source 304 and/or secondary data sources 306. If a data audit 308 fails, a notification may be prepared in an insight slide for the user, indicating recommended settings and/or other recommendations for increasing a viability of data available at primary data source 304 and/or secondary data sources 306. If/when data audits 308 pass, various API data calls 310 may be performed, where data may be requested from either or both of primary data source 304 and/or secondary data sources 306. Digital marketing data requested from primary data source 304 and/or secondary data sources 306 may be combined. Digital marketing data received from primary data source 304 and/or secondary data sources 306 may be transformed with the aid of components of an ETL library 318 (e.g., ETL components 212), before, after, or during API data calls 310.

Based on the selection of primary and secondary data sources, data audits, type of client website, and/or other information collected during user interview 302 (e.g., a job role of the user, one or more goals of the user, information about a company of the user, etc.), one or more insight modules 312 may be selected from a library of insight modules (e.g., insight modules 216). For example, the one or more insight modules 312 may be selected using a rule-based system, such as rule-based systems 220. Not all insight modules of the library may be applicable to a desired type of analysis or data. Each selected insight module 312 may perform one or more analyses 314 to generate a single insight, the generated insight based on a corresponding insight format as defined in the relevant insight module. In some cases, an insight module may include one or more ML models (e.g., ML models 218) that may be applied to generate the corresponding insight. In other cases, the various analyses may be performed via rule-based systems (e.g., rule-based systems 220), statistical analysis, or other methods. For each analysis or set of analyses 314 performed, a corresponding insight is expected to be material, significant, actionable, and explainable.

When an insight is generated, a suitable visualization 316 of the insight may be created, based on the insight format. Visualization 316 typically includes an assertion based on an interpretation of the digital marketing data, an issue detected in the digital marketing data that may be remedied by an action, a recommended action to perform, and/or an estimate of a benefit of performing the recommended action (e.g., a value to the company of performing the recommended action). Visualization 316 may also include a visual graphic visualizing and summarizing detailed results and/or data that support the insight and explain how the insight was generated. The detailed results and/or supporting data may be accessed by selecting one or more control elements of visualization 316. For example, the user may select a portion of the visual graphic, and a display panel may pop up showing the detailed results and/or supporting data. The detailed results and/or supporting data may be reviewed by the user to assess a validity of the recommended action, and/or to inform a marketing campaign, marketing strategy document, etc. In this way, the visual graphic may serve as a preview of the detailed results and/or supporting data, to aid the user in accessing desired data.

Referring now to FIG. 4A, an exemplary method 400 is shown for generating automated marketing insights from digital marketing data collected from a plurality of data sources. Method 400 and other methods described herein are described with reference to an analytics platform, such as analytics platform 102 of FIG. 1 and/or analytics platform 202 of FIG. 2; and in particular, an automated insight generation system of the analytics platform (e.g., automated insight generation system 214). Method 400 and the other methods described herein may be implemented via computer-readable instructions stored in a memory of the analytics platform, and executed by a processor of the analytics platform, such as memory 206 and processor 204 of analytics platform 202 of FIG. 2.

Method 400 begins at 402, where method 400 includes receiving information from the user of the analytics platform via an automated user interview, such as user interview 302 referred to in FIG. 3. In various embodiments, the user may log into the AI analytic platform via a GUI of the AI analytic platform (e.g., GUI 252), for example, in a browser of a computer of the user.

One advantage of the analytics platform disclosed herein is that, unlike other website and/or digital marketing analytics tools, marketing strategy recommendations generated by the analytics platform may be personalized to the user based on the information received during the automated user interview. Each user may have different job roles, priorities, goals, and questions regarding how the digital marketing data may be interpreted, which may be communicated to the analytics platform via the GUI.

For example, a first user of the client company may be a designer of an ecommerce website of the client company, where the first user may wish to receive insights regarding how an organization and/or internal navigation strategy of the ecommerce site could be changed to increase conversions. A second user of the client company may be a marketing manager seeking insights regarding how to place ads that more effectively direct customers to the ecommerce site, including where and when the ads should be placed, what ad content resonates most with target customers, and what specific pages of the ecommerce site the ads should link to. A third user of the client company may be a sales manager seeking insights regarding how lead generation may be increased.

Each of the first user, the second user, and the third user may communicate their priorities to the analytics platform in the automated user interview. The interview may be performed online via the GUI in an automated or semi-automated manner (e.g., not involving human interaction). For example, various wizards and/or widgets may be used, which may be controlled by one or more rule-based expert systems and/or AI routines. During the interviews, each user may be prompted to indicate where and how data used to generate the insights may be accessed, including credentials for logging in, parameter configuration and desired settings, and the like. Each user may rely on data received from different sources (e.g., different data collection platforms). For example, the first user may specify that the data used to generate insights about restructuring the ecommerce site should be retrieved from an ecommerce platform and a Google Analytics account; the second user may specify that the data used to generate insights about placing ads should be retrieved from the Google Analytics account and an AdSense account; and the third user may specify that the data used to generate insights about lead generation should be retrieved from the Google Analytics account and a CRM used by the client company (e.g., CRM platform 130 of FIG. 1). Thus, the personalization performed for each user may depend on the specific combinations of data sources selected by the user.

During the automated online interview, the user may be prompted to answer questions or enter in queries establishing the goals and priorities. For example, a control panel may be displayed in the GUI requesting that the user specify a primary goal for the analytics platform to use, then optimizing insight analysis (e.g., ecommerce Sales, submission of a key lead form, engagement with certain content, etc.). This may be referred to as “setting a user's intention.”. In some embodiments, the primary goal may be selected from a menu of common goals provided by the analytics platform. In other embodiments, users may be permitted to enter in text describing the primary goal. Additionally, the user may be prompted to specify one or more secondary goals.

To collect digital marketing data to achieve the primary goal and the one or more secondary goals, the user may be prompted during the automated online interview to specify a primary data source and one or more secondary data sources (e.g., primary data source 304 and secondary data sources 306 of FIG. 3). Primary data sources are where data corresponding to a user's primary goals are collected, such as Revenue, eCommerce Sales, Lead Form Submissions, and the like. For example, primary data sources may include data sources such as Google Analytics, Hubspot, Salesforce and/or Shopify.

The secondary data sources are used to make collected data richer, but analysis may still be focused on optimizing a user's primary goal. For example, a user may pick Google Analytics as their primary data source, and “Newsletter Signup” as their primary goal. The user may then add Google Search Console as a secondary data source. Google Analytics data can then be used to identify landing pages with the highest newsletter sign up conversion rates. Google Search Console can be used to identify the search queries leading to those highest converting pages to inform a paid advertising strategy.

Specifying the primary data source and the one or more secondary data sources may include specifying an online location of the primary data source and the one or more secondary data sources, login and/or authentication credentials, connection data, and/or configuration information, where the configuration information may specify types of digital marketing data to collect, times during which the digital marketing data is to be collected, dated to be ignored, and/or other settings or parameters of the primary data source and the one or more secondary data sources. For example, a user may configure a data source to retrieve data from a first audience, and not retrieve data from a second audience.

The AI used by the analytics platform may focus on improving the primary goal regardless of the data source. This may allow the user not to have to consistently define goals throughout a digital marketing ecosystem (e.g., ecosystem 100), and may discourage the user from conducting a siloed analysis. Once a user sets a primary data source and goal, the AI may discover relationships with respect to that goal across a plurality of data sources. The AI may automatically identify correlates of the primary goal within other data sources, to identify behaviors that may increase an achievement of the primary goal (e.g., microconversions). In contrast, other analytics solutions may ignore or require user inputs to identify microconversions.

For example, a user may select Hubspot as the primary data source, and a “Request a Demo Form” as the primary goal. The user may connect Google Ads as a secondary data source. Without the use of the analytics platform, the user might analyze Google Ads as being effective if they lead directly to a “Request a Demo Form Submission”, and ineffective if they do not lead directly to a “Request a Demo Form Submission”. However, because the analytics platform may rely on iterative AI routines, the analytics platform may have already identified that a certain audience is more likely to submit demo forms and/or that watching a video leads to an increased chance of submitting a demo form at a later time. The analytics platform may have already calculated a monetary value for such behaviors, and thus a return on investment (ROI) analysis of the secondary data source may be much more robust, despite a setup and effort from the user being lighter.

In other words, in the above example, the primary conversion is the ‘Request Demo Form Submission’, and the microconversion is watching the video. The AI identifies that increasing video viewings in the target audience may lead to more Demo Form conversions. With other analytics tools, the microconversion may not be identified based on a true data-driven relationship to primary goals, rather, the microconversion may be selected by marketers not based on the data. As a result, marketers may spend time inefficiently driving behaviors that do not ultimately result in positive ROI.

At 404, method 400 includes connecting to sources of digital marketing data using the online locations, login and/or authentication credentials, connection data, and/or configuration information received from the user during the automated user interview. In some embodiments, additional data sources not specified by the users may also be used. For example, the analytics platform may subscribe and/or link to one or more external data sources to supplement the data obtained from the sources specified by the users of the analytics platform.

At 406, method 400 includes auditing the primary and secondary data sources to assess viability of the digital marketing data included at the primary and secondary data sources for analyzing and generating insights. The analytics platform may audit the data with respect to the goals and priorities of each user to assess the viability of the data. Assessing the viability of the data may include assessing a sufficiency and/or availability of the data. For example, an amount of data available may not be sufficient to generate insights; data collection from a data source may not be configured correctly in the interview; the data may be inadvertently duplicated due to an incorrect parameter set during an implementation of a third-party data solution on the user's own digital property; or data may not be accessible/available for a different reason.

In some cases, a configuration of the platform may be adjusted to increase an amount of data collected. If the analytics platform detects one or more issues with the viability of digital marketing data from a data source, the one or more issues may be described in a slide, which may be sent to or otherwise made available to the respective user, who may reconfigure the data source to address the one or more issues. In some embodiments, the user may perform the automated online interview a second time to adjust the configuration. Additional information related to the one or more issues may also be presented in the slide. For example, an estimated priority for resolving each issue may be assigned; notes may be automatically generated with respect to the issue; a link to additional information may be generated; and so on.

Referring briefly to FIG. 5, an example audit result slide 500 is shown, including issues detected with respect to the viability of digital marketing data from a Hubspot configuration. Slide 500 includes a header 502, which may be an explanatory statement indicating that issues have been detected. In various embodiments, header 502 may be generated by selecting a suitable template and customizing the suitable template to reflect the audit perform. Slide 500 may include an issue table 504, which may list the issues detected during the audit along with corresponding information about each issue (e.g., features, variables, status, priority, notes, etc.) The issues may be ordered based on an assigned priority, as shown in FIG. 5.

Returning to FIG. 4A, if an audit determines that the digital marketing data is not viable, the analytics platform may not generate marketing insights based on the digital marketing data. If a viability of the data is acceptable, but could be increased, the analytics platform may indicate to the respective user, for example, via a slide such as example audit result slide 500 and may also proceed to generate marketing insights from the digital marketing data to an extent possible.

It should be appreciated that additional auditing may be performed on the digital marketing data used to generate a specific insight at a time of generating the specific insight at a relevant insight module. If the data relied on to generate the specific insight is viable, the specific insight may be generated. If the data relied on to generate the specific insight is not viable, the specific insight may not be generated. For example, the specific insight may rely on analyzing data collected over an amount of time, where if data is available for a lesser amount of time, the specific insight may not be generated.

Auditing the data may include performing various different individual audits of different types, where each of the individual audits may check for a presence and validity of a different kind or kinds of data. For example, an exposure audit may determine whether sufficient valid ad account (e.g., Facebook, LinkedIn, Google Ads, Search Console, etc.) data exists; an exploration audit may determine whether sufficient valid data regarding onsite behavior exists (e.g., via Google Analytics, Shopify, etc.); an evaluation audit may determine whether sufficient valid nurturing data exists (e.g., via Hubspot, Salesforce, Mailchimp Klavio, etc.); and an experience/purchase audit may determine whether sufficient valid CRM data exists (e.g., via Hubspot, Salesforce, Mailchimp Klavio, etc.). Each type of audit may be selected based on the combination of data sources selected and user profiles.

Referring briefly to FIG. 4B, an exemplary method 450 is shown for auditing a plurality of data sources to determine the viability of digital marketing data included in the data sources. It should be appreciated that method 450 describes a general methodology, where the steps of method 450 may not all be carried out or may be carried out in a different order.

At 452, method 450 may include reviewing a data presence in core functional fields to see if sufficient correct data values exist within a meaningful time period (data sufficiency, consistency, and recency). Depending on an analysis to be performed, an amount of the digital marketing data may not be above a threshold amount of data that is relied on to generate an insight. For example, a first analysis (e.g., a Pareto Product analysis) may not be run if there are less than 10 products. A second analysis (e.g., Seasonality Detection analysis) may not run if there are less than four repeated seasons of data (e.g., 4 years, 4 months, 4 weeks, etc.), No analysis may be performed on a digital property if there are less than 100 sessions in a 30 day period. For a plurality of analytics modules, each analytics module may have independent viability standards.

If there are inconsistencies in the digital marketing data (e.g., inconsistencies across data collected from different data sources and/or data from one data source that is not consistent with data from a second data source) that cannot be resolved via a transformation, the analysis may not be performed. The analysis may depend on the digital marketing data being collected within a specified window of time extending back from a current date, where if the digital marketing data exceeds a threshold recency, the analysis may not be performed.

As one example, the analytics platform may assess whether a Hubspot user has configured Sales Attribution properly, where leads with a status of “Became a Customer” would also be expected to have values for Total Revenue, Recent Deal Close Date, and/or other fields. If those values are missing, an alert may be generated, a notification slide may be prepared, and the platform may not move forward with any monetization analysis. As another example, a user may indicate that “Form Submits” are their primary goal and their Google Analytics account as the primary data source, but the analytics platform may perform the threshold comparison described above, and as a result of the comparison, detect that the “Form Submit” goal is not collecting data. In such cases, an alert may be generated, the notification slide may be prepared, and the platform may not move forward with any analysis designed to increase “Form Submits”.

At 454, method 450 may include scanning data output and management API configuration options to review whether values exist for variables or dimensions relied on by one or more AI routines performed during analysis of the digital marketing data. In various embodiments, the analytics platform may maintain a list of variables relied on to generate the AI.

At 456, method 450 may include scanning a target website domain (e.g., of a client company of the user, such as client company 104 of FIG. 1) for onsite technologies and capabilities, to verify whether digital marketing data that is expected to be analyzed is present. For example, a scan of a domain may reveal that a website is built on Shopify (an ecommerce platform), but no revenue may be detected in Google Analytics for the last 90 days.

At 458, method 450 may include combining data source audits across data sources to determine whether the data sources include reliable and sufficient data across an entire customer journey of the user or expected set of analyses to perform (e.g., during an amount of time the user spends interacting with the analytics platform and reviewing marketing insights and/or marketing data outputted by the analytics platform). For example, passing audits from each of an exposure audit, an exploration audit, an evaluation audit, and an experience/purchase audit may indicate that the data is reliable and sufficient across the entire customer journey, while insufficient, incomplete, or invalid data detected by any of the above audits may prompt one or more notifications.

Thus, auditing the plurality of sources of digital marketing data may rely on a cascading, decision-tree approach, where a first type of data anticipated from a first data source may be used to audit data from a second data source; a second type of data anticipated from the second data source may be used to audit data from a third data source; and so on. In contrast, a manual audit process may entail performing a more comprehensive (uninformed) set of audit tasks on each data source, where data viability at a later step in a series of analyses may not be determined until after analyses are performed in prior steps, resulting in wasted time and effort. In this way, the overall audit process may be performed more rapidly and efficiently than performing a generic audit on data of each data source at a time of use. Additionally, an amount of computational and/or memory resources used may be reduced, increasing an efficiency of a computing device (e.g., a server) that the analytics platform runs on.

Returning to FIG. 4A, at 408, method 400 includes determining whether the digital marketing data audited at 406 is viable for analysis. If at 408 it is determined that the digital marketing data is not viable, method 400 proceeds to 410. At 410, method 400 includes generating a slide indicating issues detected and recommended actions for increasing data viability, and method 400 ends. Alternatively, if at 408 it is determined that the digital marketing data is viable for analyzing and generating marketing insights, method 400 proceeds to 412.

At 412, method 400 includes extracting, transforming, and loading data from the plurality of data collection platforms. The digital marketing data collected from the data sources and retrieved by the analytics platform may be transformed (e.g., cleaned, sanitized, scrubbed, and/or curated) prior to performing various analyses. In should be noted that unlike competing analytics tools providing robust analysis, the analytics platform advantageously does not rely on “data lakes” of cleaned or combined data, which have several disadvantages. Building data lakes may be expensive, as they rely on ongoing expertise from data architects and data storage costs. Additionally, when data is transformed, some original data may be dropped or lost, limiting a company's ability to add further sophistication in the future. Further, relying on a “single source of data” often results in a data set that is either too simple to drive action, or too complex to work with.

In contrast, the analytics platform as described herein takes a novel approach to data ingestion and transformation based on achieving minimum viable data, where ingestion and transformation of sufficient data is performed immediately prior to conducting one or more analyses, and data is not stored afterwards. This allows the user to get real-time analysis without investing in a data architecture team, large databases, or sacrificing data integrity. Additionally, transformation processes are performed on the analytics platform, so a client's raw data remains untouched. This further ensures that digital marketing data used for the analysis is recent and relevant.

One technical challenge in performing data ingestion and transformation in this manner, in particular when multiple data sources are used, is that the data transformation is expected to occur within a short time frame (e.g., a matter of minutes) to meet user demands for responsiveness. To address this, queries that are performed are kept concise and precise so that operations can be rapidly performed on the data. To ensure that the queries are sufficiently concise and precise, the analytics platform may automatically break large queries up into smaller queries. However, data call limitations are also imposed by API constraints and limits of different data sources. For example, an analytics platform used as a data source may allow a maximum of 1,000 calls per view, per day. Thus, analyses performed by the analytics platform may be configured to run within this limitation, while also keeping the data calls small and precise enough to perform in near real time.

To perform the data calls while adhering to such constraints, the analytics platform may structure data calls entailed by the queries as a smart network, where a data call may refine and inform one or more downstream data calls. Similar to the cascading, decision-tree approach described above with respect to the auditing process, data calls for auditing tasks may be used to determine a set of relevant data analysis calls, and data calls for higher-level analysis tasks may be used to determine a set of lower-level analysis calls. By using results of higher-level analyses to inform how lower-level analyses should be carried out, a number of data calls and a time spent requesting and retrieving data may be decreased.

Additionally, to submit a large number of queries and apply various transformations to data received from multiple sources, the analytics platform executes data ETL processes and analysis workflows in parallel for each user. The ETL processes may be based on a library of ETL components (e.g., ETL components 212) created by the analytics platform, where different ETL components are relevant to different variables, and an ETL component may be selected based on a specific, automatically determined demand.

The automatic data transformation may entail addressing specific quality issues with ingested data individually, in series or in parallel. For each issue, a different ETL component may be selected. In other words, for a first issue, a first ETL component may be selected, and a first data transformation procedure of the first ETL component may be performed on the ingested data. For a second issue, a second ETL component may be selected, and a second data transformation procedure of the second ETL component may be performed on the transformed data. For a third issue, a third ETL component may be selected, and a third data transformation procedure of the third ETL component may be performed on the transformed data, and so on. Each of the data transformation procedures may increase a quality of the ingested data in a different manner, where the quality may be assessed based on various consistency and standardization criteria.

For example, one issue that may prompt a transformation may be case sensitivity. Some analytics tools, such as Google Analytics, are case sensitive and/or punctuation sensitive. As a result, aggregating data in a meaningful way may be difficult and tedious, both using these tools and/or tools that rely on these data sources. To address this issue, when case sensitive tools are selected as data sources by a user, the analytics platform may remove case sensitivity and common punctuation differences after data ingestion and prior to data aggregation. For example, a first user may access a client website and search for “Men's Shirts”; a second user may access the client website and search for “men's shirts”; and a third user may access the client website and search for “mens shirts”. As a result, an analysis performed on the website by some analytics tools may be based on three different search terms, while a business owner may be interested in knowing how many customers search for men's shirts as a whole and what percentage of the customers make a purchase to understand how to better meet the customer demands. To facilitate proper aggregation of the similar search terms, the analytics platform may remove the case sensitivity and homogenize the punctuation prior to aggregating and analyzing the data.

As a second example, variance in uniform resource locator (URL) query strings referencing the same page of a client website may generate problems when aggregating data. URL query strings are elements inserted in the URLs to help filter and organize content or track information on a website. For example, a URL “https://www.domain.com/shoes” could have query strings such as ‘https://www.domain.com/shoes?sessionid=bluesneakers” or “‘https://www.domain.com/shoes?rank=newest”. As a result, determining how many site visitors access a shoe page of a store may demand familiarity with setting up segments or filters, which a client may not have. In some cases, users may have to choose between removing all query strings from an account permanently, thereby losing data, or not being able to aggregate the data. Therefore, when analyzing page-level data, the analytics platform may automatically check for and remove query strings before aggregation and analysis. To accomplish this, the analytics platform may maintain a library of algorithms that correct for common query string patterns.

The analytics platform may also correct for limitations and/or common mistakes made with respect to marketing campaigns set up by a client. Understanding which marketing campaigns drive traffic and ultimately sales or leads is a primary data challenge facing marketers today. Unfortunately, data tracking in this area may not be reliable. For example, an analytics tool may have low accuracy with respect to identifying traffic from campaigns of a specific social media platform, leading to incorrect attribution, which may be costly and frustrating. To increase a performance of attribution models, the analytics platform may include a custom database that includes various algorithms to correct for these issues and ensure proper attribution.

As the number of data sources increases, an application of various data transformation algorithms may become more complex. Thus, as described above with respect to auditing data and performing data calls, a database structure and associated logic for determining which correction algorithms to apply may advantageously reduce an overall processing time and/or a use of processing resources, via queries that take into consideration a flow of data from and through a plurality of specified sources and tools. For example, data from a first source may be an input into a second source, and data from the second source may be an input into a third source. Based on the first source, the second source, and the third source, one or more algorithms that correct for known data tracking issues of any of the first, second, or third sources may be retrieved from the database and applied at an appropriate stage of analysis.

Digital marketing data may be normalized prior to performing an analysis. For example, the digital marketing data may be normalized to conduct meaningful year-over-year analysis, understand seasonality, make comparisons to industry benchmarks, and so on. In such cases, the analytics platform may automatically determine whether the digital marketing data should be normalized, and the analytics platform may automatically normalize the data. For example, comparing year-over-year performance for major shopping holidays in the U.S. (e.g., Black Friday, Cyber Monday, Christmas, etc.) may be complicated by the fact that the calendar dates of these shopping holidays change each year. To control for this, several years of data for a relevant holiday may be normalized, where each day leading up to the holiday may be converted to a number of days leading up to the major shopping holiday. This enables real year-over-year comparisons on and leading up to major holidays.

In some embodiments, the data from the plurality of data sources may be merged to form a single dataset from which insights may be generated. In other embodiments, the data from the various data sources may not be merged and may be maintained as separate datasets. Maintaining the data in separate datasets may facilitate data triangulation, where results obtained from analyzing a first dataset from a first source may be used in a subsequent analysis of a second dataset from a second source.

At 414, method 400 includes analyzing the extracted digital marketing data and generating personalized insights for the user using the automated insight generation system. In various embodiments, different types of analyses may be informed by goals and priorities of the user received during the automated user interview. Additionally, different types of analysis may be informed by an amount or type of data sources used. A plurality of data sources may be advantageously used together, in accordance with an ecommerce strategy and/or a lead generation strategy. It should be appreciated that analyzing the extracted digital marketing data and generating personalized insights may include auditing, extracting, and transforming the digital marketing data at various times during performing various analyses of the digital marketing data.

At 416, analyzing the data may include selecting one or more insight modules, based on the collected digital marketing data and information received during the automated user interview. Each selected insight module may generate a single insight with a specific format and type. In one embodiment, the automated insight generation system may proceed through a pre-established list and/or library of insight types or modules. For each insight type, the automated insight generation system may apply one or more AI and/or ML models to the data, to determine whether the data supports generation of an insight corresponding to the insight type. For some insight types, the data may support insight generation, and for other insight types, the data may not support insight generation. As described above, determining whether the data supports generation of the insight may include auditing the specific data for viability. If the data is not viable for insight generation, an insight may not be generated, and the automated insight generation system may proceed to the next insight type. Additionally, one or more ETL tasks may be applied to transform the collected digital marketing data based on the specific type of analysis performed at a relevant insight module.

In some embodiments, the automated insight generation system may filter the pre-established list or library of insight types to generate personalized insights that focus on priorities and/or goals of the user received via the interview, and not generate insights that are not relevant to the priorities and/or goals. For example, if a user is in charge of paid media, the automated insight generation system may filter the insights to display marketing insights relevant to paid media—in other words, opportunities the user will act on—and to not display marketing insights that are not relevant to paid media. Thus, insights can be tailored to specific users, for example, within a client company of the analytics platform.

At 418, analyzing the data includes, for each insight module, applying one or more AI-based methods and/or techniques to relevant digital marketing data to generate personalized marketing insights. The one or more AI-based methods and/or techniques may include rules-based systems and/or ML models, such as the ML models 218 and rule-based systems 220 of FIG. 2. Applying the one or more AI-based methods and/or techniques may include combining and/or cross-referencing data extracted from different sources or applying the one or more AI-based methods and/or techniques in series or in parallel to the data extracted from different sources. Applying the one or more AI-based methods and/or techniques may also include performing an analysis over a series of steps or iteratively applying an AI-based method.

As an example, in a first step, data collected from a company via a web analytics tool (e.g., Google Analytics) may be cleaned, aggregated, and used to identify a set of pages that do not typically lead to a conversion. In a second step, the set of pages may be cross-referenced against data collected from a search engine advertising program of the company (e.g., Google AdSense), to identify paid campaigns sending customers to those pages, which may be money poorly spent. In a third step, (e.g., additionally or alternatively), the set of pages may be inputted into one or more speed testing sites (Google Page Speed, Web Page Test, Dynatrace, etc.) to determine whether slow page loading or performance impacts customer abandonment data collected from the web analytics tool. In a fourth step, the set of pages may be analyzed using one or more ML models of the analytics platform that are trained to identify examples of page elements that are influential in prompting customer decisions, like well-written calls-to-action, social proof, etc. In a fifth step, the set of pages may be analyzed in conjunction with an eye-tracking technology partner (e.g., technology partners 150) to determine which page elements are most likely viewed by users and to assess a placement of the page elements in the set of pages. In a sixth step, the set of pages may be inputted into one or more search engine optimization (SEO) sites/services, which may detect issues that fail to direct users to a desired page.

As another example, during the online interview, the user may specify key topics of interest to a client business, such as “cloud computing”, “prescription sports eyewear”, “teach abroad programs”, etc. In a first step, the top-ranking pages for each topic within each competitor domain may be automatically identified by the analytics platform using a first data source (e.g., a search engine). In a second step, the analytics platform may execute an API call loop to an SEO scoring site (e.g., SEO Surfer) to calculate an SEO optimization score for each page and topic. In a third step, the analytics platform may perform an iterative process to feed both competitor data and top overall ranking content into a content generation AI (e.g., a third data source). The generated content may be rescored using the second data source after each stage. The loop may automatically stop when a target score is achieved. In a fourth step, the new content generated by the content generation AI may be used to generate additional keyword recommendations and filters to those key terms with a cost profile configured to meet ROI targets (e.g., depending on the current site goal value and conversion rates). A marketing insight may then be generated including an indication of how each page ranks against competitors, the marketing insight including auto-generated content and ad campaigns that could be used to increase market share.

In this way, the analysis or analyses may be performed in a chained or cascading fashion, where a result of analyses are used in subsequent analyses until a desired insight can be generated. It should be appreciated that the steps described above may be performed in various orders, where an output of one step may influence the output of a subsequent step. In some examples, additional steps may be added. In some scenarios, data outputted by a data source may undergo a subsequent transformation process to clean or curate the resulting data before applying a subsequent process or step. In some implementations, the data output by the data source may also undergo an audit process to determine whether it would be sufficiently beneficial to perform a subsequent analysis. When the steps have been completed, an insight may be generated, in this case, that identifies specific pages leading to drop off, paid ads to redirect, and/or recommended on-page optimizations to test.

Thus, the plurality of sources may be used advantageously and in a novel manner to automate steps of a laborious and time-consuming manual procedure to produce a similar result. Without the analytics platform, a user would have to be able to (1) determine what the monetary content attribution should be for any given page; (2) identify top volume pages not performing at an expected monetary value; (3) go to a search engine or display network advertising program and identify campaigns landing on each of these pages; (4) take the list of pages and run each individual page through a site speed analysis tool to identify potential issues; (5) manually review each page on a desktop and mobile device to see if the content has clear calls to action, follows best practices, has a good user experience, etc.; (6) take the list of pages and login to various other page-level AI tools like eye tracking and copy writing tools to identify other opportunities; and so on. These steps may take a significant amount of time, they may additionally rely on substantial user expertise.

At 420, method 400 includes generating visual presentations of a plurality of personalized marketing insights generated from the analysis. The visual presentations may follow specific formats based on the type of insight. In various embodiments, the automated insight generation system may encode the insight in an intermediate, data-interchange format that may allow the plurality of personalized marketing insights to be exported to different file formats, such as Microsoft PowerPoint, Microsoft Word, Google Slides, etc. In some embodiments, the visual presentations may be displayed on the display device (e.g., display device 250 of FIG. 2), while in other embodiments, the visual presentations may be displayed on a display device of the user, or a different viewer. Generating the visual presentations is described in greater detail below in reference to FIG. 4C.

At 422, method 400 includes outputting the visual presentations of the marketing insights in a native format, based, for example, on the metadata generated at 420, to be viewed by the user. For example, the visual presentations may be packaged as a series of slides, where a viewer may select a relevant slide corresponding to a marketing insight by selecting the relevant slide in a menu (e.g., of a slideshow). Alternatively, visual presentations may be packaged in an HTML format for viewing in a web browser, where the viewer may select a relevant slide corresponding to a marketing insight by selecting the relevant slide in a menu of links. The viewer may proceed down the menu of links or slides, viewing the insights in a sequence. In some examples, the slides may be listed in the menu in an order, for example, according to a priority score assigned to the marketing insights by the automated insight generation system.

One advantage of using the data-interchange format is that a same visualization of a personalized marketing insight may be exported into various native formats of visual presentation software for review by the user. For example, a first user may choose to open the marketing insights in a PowerPoint slide show; a second user may choose to open the marketing insights in an Excel spreadsheet; a third user may choose to open the marketing insights in Google Slides; and so on. In some embodiments, a selected native format may be indicated by the user during the online interview. In other embodiments, the selected native format may be indicated by the user at a time of receiving the marketing insights. In still other embodiments, the selected native format may be automatically selected, for example, by the rules-based systems and/or ML models.

After the visual presentations of the marketing insights are exported and packaged in the native format, the visual presentations may no longer be linked to the analytics platform. In other words, the data presented in the marketing insights, including the recommended action, the digital marketing data used to generate the recommended action, and additional text and/or graphics used to summarize the digital marketing data may be included in the visual presentations. As a result, the user may view the data without launching or logging into the analytics platform. Further, the data may not be stored on the analytics platform, thereby reducing a security risk to the company and reducing a use of memory and processing resources by the analytics platform. The visual presentations may be reviewed by the user using a standalone application on a computing device (e.g., a desktop computer, a tablet, a smart phone, etc.), such as, for example, Microsoft PowerPoint, Google Slides, or a different software application, without relying on an Internet connection connecting the computing device to the analytics platform. The visual presentations may not rely on the analytics platform being operational and may be reviewed when the visual presentations are not electronically connected (e.g., via the Internet) to the analytics platform, or when the analytics platform is in an unlaunched state. An additional advantage of generating the visual presentations in the data format is that the user may cut, paste, edit, embellish, or remove portions of the marketing insights, for example, to prepare a proposal for a new marketing strategy.

Turning now to FIG. 4C, an exemplary method 480 is shown for generating a customized visual presentation of a marketing insight generated by an automated insight generation system of an analytics platform, such as automated insight generation system 214 of analytics platform 202 of FIG. 2. Method 480 may be performed by a visual presentation module of the analytics platform (e.g., visual presentation module 222). In various embodiments, method 480 may be executed as part of method 400 of FIG. 4A.

Method 480 begins at 482, where method 480 includes receiving a marketing insight from the automated insight generation platform. At 484, method 480 may include calculating an estimated value to the user, or a company of the user (e.g., a client company of the analytics platform for which the user works for or represents), of acting on a recommended action included in the marketing insight. The estimated value may be presented to the user such that the user may review, compare, and prioritize different marketing insights (e.g., recommendations included in the different marketing insights) based on the estimated value. In various embodiments, the marketing insights may be presented in a ranked order based on the estimated values of the marketing insights. For some marketing insights or insight types, no estimated value may be generated.

The estimated value to the client company of acting on the recommended action may be calculated based on various parameters. For example, some recommendations may be easy and inexpensive to act on, while acting on other recommendations may entail substantial development efforts with an associated labor cost. Some recommendations may be acted on quickly with near-immediate results. Some other recommendations may take time, even if inexpensive to implement. Thus, the estimated value may be calculated as a function of the various parameters to achieve a balance between cost, effort, short-term goals, and long-term goals of the client company. In one embodiment, the estimated value may be calculated as a weighted value comprising a plurality of parameters with different weights.

A first parameter of the plurality of parameters may be an expected monetary value of acting or not acting on the marketing insight. For example, the estimated value may be calculated based on comparing revenues of the client company that might be generated in different alternative scenarios (e.g., acting on a recommendation presented in a marketing insight vs. not acting on the recommendation). As an example, an insight module for an ecommerce strategy may analyze website data to identify high-volume pages not commonly included in purchase paths. A potential customer (e.g., a customer 106 of FIG. 1) may click on a link in an email or an ad, and the link may direct the potential customer to a page of the website. However, some of the links clicked on by customers may take the customers to lower-performing pages where a higher percentage of potential customers do not make purchases or do not continue navigating to a page where the customers make a purchase. Alternatively, other links clicked on by customers may take them to higher-performing pages where a higher percentage of potential customers make purchases or continue navigating to a page where the customers make a purchase. The insight engine may apply one or more AI and/or ML models to analyze the purchase path data and determine specific pages where users abandon their searches. The insight module may then analyze ad data to determine which pages customers are directed to. If the insight module determines that revenue could be increased by adjusting ads to direct potential customers to pages that are more likely to result in a sale, the insight module may generate a corresponding insight. The corresponding insight may include a calculation of how much revenue could have been generated if the ads were adjusted as indicated.

A second parameter of the plurality of parameters may be a longevity of a benefit received by acting on a recommendation, or a “shelf life” of the recommended action. The longevity of the benefit may be determined for the relevant type of insight by a rules-based system of the relevant insight module (e.g., a rule-based system 220 of FIG. 2). For example, fixing a site speed of a website may have a higher longevity as the benefit obtained may last a long time. In contrast, marketing a top performing product during a holiday season may have a shorter longevity.

A third parameter of the plurality of parameters may be an ease of implementation, based on general estimates for the type of insight. For example, adding keywords to an ad campaign may have a high ease of implementation, while rebuilding a website may be assigned a low ease of implementation. The ease of implementation may be determined by for the relevant type of insight by a rules-based system of the relevant insight module.

A fourth parameter of the plurality of parameters may be an assessment of a compatibility or fit with developmental and marketing resources of the client company. In some embodiments, the user may specify the developmental and marketing resources in the online interview (e.g., the online interview 302 of FIG. 3) or at a different time. The relevant insight module may compare types and/or amounts of work entailed by the recommended action with the developmental and marketing resources to determine a level of compatibility. For example, a website redesign recommendation may be assigned a higher compatibility if the client company employs an in-house web development team than if the client company does not have dedicated developers.

Calculation of the parameters may be performed using various rule-based applications, ML models, lookup tables, and/or other techniques. These parameters may be used to calculate a total score (e.g., the estimated value) which may be used to rank and sort the marketing insights. The parameters may be weighted in accordance with a weighting scheme, which may be configured by the user during the interview.

Referring briefly to FIG. 8A, an exemplary visual presentation of a weighting scheme 800 of an estimated value (e.g., score) 801 is shown, where weighting scheme 800 may be defined by a user of the analytics platform during an online interview. Weighting scheme 800 includes four parameters shown in four display panels oriented around the score, which is depicted in FIG. 8A as “XX” out of a total possible score of 100. Weighting scheme 800 includes a first display panel 802, which shows a weighting of 50% for a business value parameter; a second display panel 804, which shows a weighting of 20% for an ease of implementation parameter; a third display panel 806, which shows a weighting of 15% for a longevity parameter; and a fourth display panel 808, which shows a weighting of 15% for a team fit parameter, where the four weightings add up to 100%.

Returning to FIG. 4C, once the estimated value to the client company has been calculated, a visual presentation may be generated for the marketing insight. In various embodiments, the visual presentation may be a slide or combination of linked slides, where the marketing insights collectively may form a slideshow including the slides or combination of linked slides. In some examples, the slides may have various components. In various embodiments, a first (e.g., main) slide summarizes the insight, while one or more additional slides provide additional details. The one or more additional slides may be accessible via links on the first slide.

At 486, method 480 includes generating a heading, where the heading comprises text (e.g., a sentence) including a recommended action and the expected monetary value for the marketing insight. In some embodiments, the heading may be composed based on the type of insight using a rule-based system. In some embodiments, natural language processing (NLP) may be used to generate the heading. For some insight types, the heading may not include an explicit recommended action. Rather, the heading may state an insight derived from an interpretation of the digital marketing data, where the insight may include an implicit recommended action. For example, the insight may point out that site visits from a given ad may have decreased, implicitly suggesting that withdrawing the ad may be considered.

At 488, method 480 includes generating a graphic showing the estimated value along with components of the estimated value. In various embodiments, the estimated value may be presented in a visual graphic within the visual presentation of the marketing insight. The visual graphic may include an estimated value, or score assigned to each parameter, which users may click on to view more details about how each parameter was calculated. The estimated values for each parameter may be monetary values, scores based on a maximum and minimum score, and/or binary values (e.g., yes/no).

Referring briefly to FIG. 8B, an exemplary visual presentation of a graphic 850 of an estimated value 851 of acting on a recommendation of a marketing insight is shown. Estimated value 851 is reflected as a score of 82 out of a total possible score of 100. Graphic 850 includes four parameters shown in four display panels oriented around estimated value 851. Graphic 850 includes a first display panel 852, which shows a business value of $103K; a second display panel 854, which shows a score for ease of implementation of 1 out of 3; a third display panel 856, which shows a longevity score of 3 out of 3; and a fourth display panel 858, which shows a team fit score of “yes”. From graphic 850, the user may determine that the business value of a company of the user acting on the relevant recommendation is significant, long-lasting, and feasible for the company, although not particularly easy to implement.

Returning to FIG. 4C, at 490, method 480 includes selecting a suitable type of graphic to illustrate and summarize the issue and customizing the graphic based on the digital marketing data. The graphic may be selected from a set of templates, based on the type of insight. For example, a first type of insight may use a first template; a second type of insight may use a second template; and so on. After the template is selected that summarizes the issue, the graphic may be customized to a relevant marketing analysis performed by the automated insight generation system and specific marketing analysis result or results obtained from the relevant marketing analysis (e.g., values of the marketing analysis result or results and/or visual representations of the values may be modified in the template).

Additionally, the graphic may be interactive, where a viewer may select the graphic, or one or more portions or elements of the graphic, to view a more comprehensive set of marketing analysis results and/or the digital marketing data supporting the marketing analysis results. For example, when a portion or element of the graphic is selected, a display panel may be displayed including the more comprehensive set of marketing analysis results and/or the digital marketing data supporting the marketing analysis results. Thus, the graphic serves as a summary of the marketing analysis results and the underlying digital marketing data interpreted to generate the insight, where the viewer may “preview” a limited number or amount of marketing analysis results and/or specific digital marketing data relevant to the marketing analysis results. For example, in an insight generated for an ecommerce strategy, the marketing analysis results and supporting digital marketing data may include a list of higher performing pages and lower performing pages, and/or a list of pages including a performance score. The graphic and the heading including the recommendation may be included together in the visual presentation, as shown in the example slides of FIGS. 6A and 6B.

FIG. 6A shows an example slide 600 generated by an analytics platform as a visual presentation of a marketing insight generated by an automated insight generation system of the analytics platform (e.g., automated insight generation system 214 of analytics platform 202 of FIG. 2), based on digital marketing data of a company extracted from one or more data sources. Slide 600 includes a heading 602, which describes a result of one or more analyses performed by the automated insight generation system. Slide 600 includes additional information 604 relating to heading 602, and a recommendation 606, where recommendation 606 is a recommended action to perform based on the result indicated in heading 602. In other embodiments, some or all of recommendation 606 may be embedded in heading 602. Slide 600 also includes a graphic 608, which shows a summarized view of the digital marketing data upon which the marketing insight is based, and a legend 610 indicating data sources from which the digital marketing data was extracted. A time span indicator 612 may indicate a time span over which the extracted digital marketing data was collected (e.g., during the last year). Slide 600 additionally includes an estimated value visual element 620, which may indicate an estimated value to the company of following recommendation 606, as described above in reference to FIG. 8B. In various embodiments, visual element 620 may be a non-limiting example of graphic 850 of FIG. 8B.

More specifically, graphic 608 may summarize a calculation of an estimated value per form submission calculated from a number of form submissions detected in the digital marketing data, a number of unique web leads detected in the digital marketing data, and a number of new customers detected in the digital marketing data. The number of form submissions is a result of a first data call to a first data source such as an analytics platform (e.g., Google Analytics). The number of unique web leads is a result of a second data call to a CRM platform (e.g., Hubspot), acting as a second data source, where the number of form submissions may be included in the second data call. The number of new customers generated by the unique web leads is a result of a third data call to the CRM platform, where the number of unique web leads may be included in the third data call.

Graphic 608 may be interactive such that a viewer may select graphic 608 to view the digital marketing data summarized by graphic 608. The viewer may be a user of the analytics platform, or the viewer may be a recipient of slide 600 who is not a user of the analytics platform. Further, portions or elements of graphic 608 may be selectable to view portions of the digital marketing data. For example, in an embodiment, the viewer may select a first element 614 of graphic 608 and, in response, a first display panel may be generated showing digital marketing data including details of the form submissions, such as a timing of the form submissions, lead data included in the form submissions, etc. The viewer may select a second element 616 of graphic 608 and, in response, a second display panel may be generated showing digital marketing data including details of the unique web leads detected in the CRM platform, such as entry dates of the unique web leads, demographic data of the web leads, etc. The viewer may select a third element 618 of graphic 608 and, in response, a third display panel may be generated showing digital marketing data including details of the new customers detected in the CRM platform, such as when first purchases were made by the new customers, one or more items purchased by the new customers, demographic data of the new customers, etc. Thus, graphic 608 may both summarize an analytical result obtained from the digital marketing data and be used to preview portions of digital marketing data that may be of interest to the viewer.

For example, a first viewer may be a web designer who is interested in form submission data; a second viewer may be a sales lead who is interested in the web lead data; and a third viewer may be an account manager who is interested in the new customer data. The first viewer may select first element 614 to access the form submission data and may not select second element 616 or third element 618. The second viewer may select second element 616 to access the web lead data and may not select first element 614 or third element 618. The third viewer may select third element 618 to access the new customer data and may not select first element 614 or second element 616. For each of the first viewer, the second viewer, and the third viewer, by selecting an element of interest of graphic 608 and not selecting other elements of graphic 608, desired digital marketing data may be more rapidly and efficiently accessed than by using an alternative analytics tool that relies on the user navigating through different types of digital marketing data from different sources.

FIG. 6C shows an example new customer view 650, which may be displayed in the third display panel described above, in response to the third viewer selecting third element 618 of FIG. 6A. Customer view 650 includes four columns, showing a customer identifier in a first column 652; a purchased product in a second column 654; a date of purchase in a third column 656; and a customer category (e.g., demographic classification of a customer) in a fourth column 658. In FIG. 6C, three customers are shown. Thus, if the third viewer wishes to determine, for example, whether new customers included in the summary of new customers of element 618 are in a same demographic category, the third viewer may select element 618 to view new customer view 650. The third viewer may review fourth column 658, where it is indicated that the new customers fall into a first demographic category and a second demographic category. In this way, element 618 offers a preview (e.g., summary) of the new customer data, and actual new customer data may be accessed via a user input. The actual new customer data is not generated at a time of selecting element 618, whereby in response to the viewer selecting element 618 a connection is reestablished with the analytics platform. Rather, the new customer data is pre-generated, but advantageously displayed in a secondary panel, to make it easier for the third viewer to understand the insight shown in a primary panel (e.g., FIG. 6A).

FIG. 6B shows an example slide 630 generated by the analytics platform as a visual presentation of a second example marketing insight generated by the automated insight generation system, based on the digital marketing data. Slide 630 includes a heading 632, which describes a result of one or more analyses performed by the automated insight generation system, and further includes a recommended action to perform based on the result. Slide 630 includes additional information 634 relating to heading 632. Slide 600 also includes a graphic 636, which shows a summarized view of the digital marketing data upon which the second example marketing insight is based, a title 640 of graphic 636, and a legend 638 explaining graphic 636.

Graphic 636 summarizes a seasonal impact on sales, where a first portion 642 of the digital marketing data relating to digital marketing data collected between January and August shows positive sales (e.g., a seasonal peak), and a second portion 644 of the digital marketing data relating to digital marketing data collected between September and December shows negative sales (e.g., a seasonal dip). The digital marketing data of portions 642 and 644 may be normalized during a transformation stage (e.g., performed by data transformation module 210 of analytics platform 202 of FIG. 2) to allow data from a plurality of years to be included in the analysis. As described above in reference to FIG. 6A, graphic 636 and/or portions 642 and 644 may offer a preview of a limited amount of digital marketing data supporting the analysis and may be selectable to view a larger amount of the digital marketing data. For example, in one embodiment, a viewer of slide 630 may select portion 642, and a first display panel may be displayed showing digital marketing data related to positive sales during seasonal peaks. The viewer may further select portion 644, and a second display panel may be displayed showing digital marketing data related to negative sales data during seasonal dips.

Returning to FIG. 4C, at 492, method 480 includes encoding a visual presentation in metadata in an intermediate, data-interchange format. The data-interchange format may include the heading, which may define the issue and propose a corresponding recommendation, and the graphic, which may summarize the digital marketing data interpreted by the automated insight generation system to support the recommendation. The digital marketing data may also be included in the metadata. For example, with respect to the example insight shown above in FIG. 6A, the supporting digital marketing data may include the new customer data shown in FIG. 6C. The metadata may also include additional data.

FIG. 7 shows an example snippet 700 of metadata generated by the automated insight generation system.

Thus, methods and systems are disclosed for generating actionable, data-driven marketing insights from raw digital marketing data collected across a plurality of data sources. The raw digital marketing data may be audited at each data source of the plurality of data sources prior to analysis, to save time and computational resources. The raw digital marketing data may be analyzed in a chained or cascading fashion, where a first set of data from a first source is analyzed to obtain a first result and, based on the first result, a second set of data from a second source is analyzed to obtain a second result. The results may be personalized for a user, the personalization being based on the user's role in a company and/or goals. The marketing insights may include an estimated value to the company as determined based on various factors as described herein.

In other words, the methods disclosed herein for generating marketing insights from raw data and presenting them in slides improves the capabilities of the automated insight generation system by reducing an amount of processing that would otherwise be performed during an interactive data interpretation process performed by a user. Insight slides are generated in a first step by the automated insight generation system using ML models and rule-based systems, and the slides are disseminated to the user in a second step for viewing via a separate, user-selected software application, during which the automated insight generation system may not be linked to the slides. Each slide includes a summary graphic of a subset of data (e.g., where the summary graphic shows a limited amount of the subset of data) that supports a given interpretation of the data, including a recommended action. If the user wishes to view the subset of data that supports the interpretation, the user may select one or more elements of the summary graphic to view the subset of data, without launching the automated insight generation system or performing any additional processing.

For example, a marketing manager of a company may wish to propose changes to a company website to an executive of the company, where a goal of the changes is to increase sales made via the website. The marketing manager may log in to the analytics platform. The platform may request information from the marketing manager regarding the goal. The marketing manager may specify sources of digital marketing data that may be interpreted to determine a set of changes to be implemented. The platform may connect to the sources and audit the digital marketing data available from the sources to assess whether sufficient data can be collected from the sources to support an interpretation. If sufficient data is not available, the analytics platform may not proceed to analyze the data, thereby saving memory and processing resources of the analytics platform. If sufficient data is available, the analytics platform may collect and analyze the digital marketing data based upon the goal specified by the marketing manager.

The analytics platform may detect various data-driven opportunities to increase the sales made via the website. Each of the opportunities may be phrased as a recommendation to the marketing manager, which may be visually presented in a slide. The recommendation may include an estimated value to the company of acting on the recommendation. The slide may include a summary graphic that summarizes elements of the marketing data that support the recommendation, where the marketing manager may view the elements of the marketing data by selecting one or more controls of the slide. The slides may be packaged into a slideshow, which may be emailed or otherwise delivered to the marketing manager.

The marketing manager may receive the slideshow and may review the slides. For each slide, the marketing manager may assess a feasibility and cost of acting on the recommendation included in the slide, by reviewing the summary graphic. The marketing manager may prioritize the recommendations based on the estimated values and/or other factors (e.g., company goals, company resources, planned campaigns, etc.). Based on the summary graphics, the marketing manager may select one or more recommendations to propose to the executive. For each selected slide, the marketing manager may select a control included in the slide to view the marketing data that supports the corresponding recommendation. The marketing manager may analyze the supporting marketing data in the selected slides (and/or selected portions of the selected slides) to assess a validity of the corresponding recommendations. Based on the supporting marketing data, the marketing manager may determine that the recommendations are valid, whereby the marketing manager may include the recommendations and supporting marketing data in the proposal to the executive. However, the marketing manager may not view marketing data supporting recommendations included in other slides (and/or unselected portions of the selected slides) that were not selected. By viewing the supporting marketing data of the selected slides, and not viewing the marketing data included in slides corresponding to lower-priority recommendations, an amount of time spent by the marketing manager interpreting the marketing data can be reduced.

Thus, the summary graphics permit the marketing manager to preview select portions of the marketing data to determine which portions are most relevant to the goal. In contrast, other analytics tools available to the marketing manager may present a more comprehensive set of marketing data via a dashboard, where the marketing manager interacts with the dashboard to narrow a scope of the marketing data based on the goal. For example, the marketing manager may select a first control of the dashboard to review a first set of data related to a conversion rate of a first page of the website. The marketing manager may subsequently select a second control of the dashboard to review a second set of data related to a bounce rate of the first page of the website. The marketing manager may subsequently select a third control of the dashboard to review a third set of demographic data related to the conversion rate of the first page of the website, and so on. Each time the marketing manager selects a control of the dashboard, the other analytics tools process the request associated with the control in a process that consumes more time, memory and processing resources than the analytics platform and the methods described herein.

Further, since the digital marketing data is analyzed by the analytics platform in a first step and provided to the marketing manager in a second step, after processing is finished, results of the processing may be reviewed while electronically unconnected to the analytics platform or while the analytics platform is in an unlaunched state. The results may be reviewed in an independent software application unrelated to the analytics platform, where the independent software application is selected by the marketing manager. For example, the marketing manager may open the slides in Microsoft PowerPoint, to create the proposal to the executive in a PowerPoint slideshow, or the marketing manager may open the slides in Microsoft Word, to create the proposal to the executive in a Word document.

In this way, the slides improve the way the automated insight generation system stores and retrieves data in memory to reduce resource consumption. A specific manner of displaying marketing insights to the user based on a limited set of digital marketing data is described, such that the user is not burdened by time-consuming, iterative calculations, or by navigating through pages of digital marketing data displayed in a dashboard of an analytics tool. Because the user is not forced to scroll down or navigate through various layers of data to interpret the data, a rapid and efficient process for communicating specific, data-driven recommendations is enabled. As a result, the time spent by the user interacting with the automated insight generation system, and an amount of processing performed by the automated insight generation system during the interaction, may be less than would be demanded by existing systems and GUIs. Thus, the disclosed systems and methods increase the efficiency of the automated insight generation system specifically, and the analytics platform in general.

The technical effect of generating marketing insights from digital marketing data using an analytics platform and displaying the marketing insights in visual presentations independent from the analytics platform, is that the digital marketing data may be interpreted more quickly and efficiently, at a lower cost, and in a manner accessible to users without expertise in data analytics, than via a dashboard-based analytics tool.

The disclosure also provides support for an analytics platform for providing automated digital marketing analysis, the platform comprising an automated insight generation system configured to: collect digital marketing data from a plurality of data sources identified by a first user, analyze the digital marketing data, generate one or more actionable marketing insights based upon the analyzed digital marketing data, generate a visual presentation of the one or more generated actionable marketing insights, the visual presentation comprising at least one recommended action, one or more elements of the analyzed digital marketing data providing support for the at least one recommended action, a visualization summarizing the one or more elements, and an estimated value to the user of performing the at least one recommended action, and providing the visual presentation of the one or more generated actionable marketing insights to the user such that the user can access the visual presentation while the analytics platform is in an unlaunched state. In a first example of the system, the automated insight generation system is further configured to: audit the plurality of data sources to determine a viability of the digital marketing data for generating the one or more actionable marketing insights, and in response to the audited digital marketing data not being viable, recommend to the user one or more adjustments to one or more configuration settings of the plurality of data sources, extract the audited digital marketing data from the plurality of data sources, transform the extracted digital marketing data, to increase a quality of the extracted digital marketing data for generating the actionable marketing insight, and analyze the transformed digital marketing data. In a second example of the system, optionally including the first example, the auditing of the plurality of data sources further comprises: checking a presence of digital marketing data in core functional fields of the plurality of data sources for sufficiency, consistency, and recency, determining whether variables relied on by one or more rule-based systems and machine learning (ML) models of the analytics platform are present in the plurality of data sources, scanning a website domain of the plurality of data sources for onsite technologies, and combining audits of different data sources of the plurality of data sources to determine whether the different data sources include data this is reliable and sufficient across an expected set of analyses to perform. In a third example of the system, optionally including one or both of the first and second examples, the combining of the audits of different data sources of the plurality of data sources further comprises: performing a first audit of a first set of digital marketing data collected from a first data source, and based on a result of the first audit, performing a second audit of a second set of digital marketing data collected from a second data source. In a fourth example of the system, optionally including one or more or each of the first through third examples, the transforming of the extracted digital marketing data includes: removing case sensitivity and common punctuation differences in the digital marketing data, removing query strings in web addresses of the digital marketing data, applying one or more custom algorithms specific to a data source of the plurality of data sources to the digital marketing data, to correct for limitations and/or common mistakes made with respect to marketing campaigns and ensure proper attribution, normalizing the digital marketing data, and merging digital marketing data from two or more data sources of the plurality of data sources. In a fifth example of the system, optionally including one or more or each of the first through fourth examples, the automated insight generation system is further configured to audit, extract, and transform the digital marketing data a plurality of times during performing a plurality of analyses of the digital marketing data. In a sixth example of the system, optionally including one or more or each of the first through fifth examples, the automated insight generation system is further configured to select one or more analyses to perform on the digital marketing data from a set of available analyses based on information provided by the user, the information provided by the user including: a role of the user at a company of the user, a primary goal of the user, one or more secondary goals of the user, information for accessing one or more data sources of the plurality of data sources. In a seventh example of the system, optionally including one or more or each of the first through sixth examples, the automated insight generation system is further configured to: perform a first analysis of a first set of digital marketing data collected from a first data source of the plurality of data sources, to generate a first result, based on the first result, perform a second analysis of a second set of digital marketing data collected from a second data source to generate a second result, and generate the one or more actionable marketing insights based on the second result. In a eighth example of the system, optionally including one or more or each of the first through seventh examples, the estimated value is generated based on at least two of: an estimated monetary value associated with implementing the recommended action, an estimated longevity of a benefit of implementing the recommended action, an estimated difficulty of implementing the recommended action, and an estimated feasibility of the user implementing the recommended action, based on information regarding technological, labor, and/or other available resources specified by the user. In a ninth example of the system, optionally including one or more or each of the first through eighth examples, the digital marketing data is not stored on the analytics platform after the visual presentation of the marketing insights is generated.

The disclosure also provides support for an analytics platform comprising a display device, the analytics platform being configured to display on the display device a menu of data-driven marketing insights generated by the analytics platform based on digital marketing data from a plurality of data sources, each data-driven marketing insight including marketing analysis results viewable on the display device, and additionally being configured to display on the display device, for each marketing insight, a visual presentation summarizing the marketing analysis results that can be reached directly from the menu, wherein the visual presentation includes a graphical depiction of the data-driven marketing insight including a limited selection of the marketing analysis results used to generate the data-driven marketing insight, each marketing analysis result in the limited selection being selectable to launch a display panel and enable at least the selected marketing analysis result and digital marketing data supporting the selected marketing analysis result to be seen within the display panel, and wherein the visual presentation is displayed on the display device while the analytics platform is in an unlaunched state. In a first example of the system, a data-driven marketing insight is personalized for a user of the analytics platform, based on information provided to the analytics platform during an automated online interview of the user conducted via a GUI of the analytics platform. In a second example of the system, optionally including the first example, the data-driven marketing insight includes a score indicating an estimated value to the user of implementing the data-driven marketing insight. In a third example of the system, optionally including one or both of the first and second examples, generating the data-driven marketing insight based on the digital marketing data from the plurality of data sources further comprises: auditing the plurality of data sources for a sufficiency, a consistency, and a recency of the digital marketing data, in response to the digital marketing data not being sufficient, consistent, or sufficiently recent, generating a recommendation for adjusting one or more configuration parameters of one or more data sources of the plurality of data sources, and in response to the digital marketing data being sufficient, consistent, and sufficiently recent, performing a first analysis of data from a first data source of the plurality of data sources, and using a result of the first analysis in a second analysis of data from a second data source to generate the data-driven marketing insight.

The disclosure also provides support for a method for an analytics platform, the method comprising: collecting digital marketing data from a plurality of data sources specified by a user of the analytics platform, analyzing the digital marketing data collected from the plurality of data sources using one or more machine learning (ML) models of the analytics platform, based on the analyzed data, generating a visual presentation of an actionable marketing insight, the actionable marketing insight including at least a recommended action to perform to achieve a benefit, a summary of a portion of the analyzed data that supports the recommended action, the summary selectable to view the portion of the analyzed data, and an estimated value to the user of the benefit achieved by performing the recommended action, wherein the visual presentation is not displayed in a dashboard of the analytics platform, and the visual presentation is viewable on a computing device of the user, while the analytics platform is in an unlaunched state. In a first example of the method, the analyzing of the digital marketing data collected from the plurality of data sources further comprises: performing a first analysis of a first set of digital marketing data collected from a first data source of the plurality of data sources, to generate a first result, based on the first result, performing a second analysis of a second set of digital marketing data collected from a second data source, to generate a second result, and generating the actionable marketing insight based on the second result. In a second example of the method, optionally including the first example, the analyzing of the digital marketing data further comprises, prior to analyzing the digital marketing data: reviewing a presence of digital marketing data in core functional fields of the plurality of data sources for sufficiency, consistency, and recency, determining whether variables relied on by one or more rule-based systems and/or machine learning (ML) models of the analytics platform are present in the plurality of data sources, scanning a website domain of the plurality of data sources for onsite technologies and/or capabilities, and transforming the digital marketing data to increase a quality of the digital marketing data for generating the actionable marketing insight. In a third example of the method, optionally including one or both of the first and second examples, the transforming of the digital marketing data further comprises: checking for case sensitivity and common punctuation differences in the digital marketing data, and in response to detecting the case sensitivity and common punctuation differences, removing the case sensitivity and common punctuation differences from the digital marketing data, checking for query strings in web addresses of the digital marketing data, and in response to detecting one or more query strings in the web addresses of the digital marketing data, removing the one or more query strings from the web addresses of the digital marketing data, checking for limitations and/or common mistakes made with respect to a configuration of a marketing campaign, and in response to detecting the limitations and/or common mistakes, applying one or more custom algorithms to the digital marketing data to correct for the limitations and/or common mistakes, checking for digital marketing data that would benefit from normalization, and in response to detecting digital marketing data that would benefit from the normalization, normalizing the digital marketing data, and merging digital marketing data from two or more data sources of the plurality of data sources. In a fourth example of the method, optionally including one or more or each of the first through third examples, analyzing the digital marketing data collected from the plurality of data sources and generating the actionable marketing insight further comprises: receiving information from the user via a graphical user interface (GUI) of the analytics platform, the information including at least one of a job role of the user, a marketing goal of the user, and a description of marketing and/or development resources of an organization of the user, based on the received information, selecting one or more analyses to perform on the digital marketing data, out of a total number of permitted analyses, performing the selected analyses on the digital marketing data to generate a result, and generating the actionable marketing insight based on the result. In a fifth example of the method, optionally including one or more or each of the first through fourth examples, the estimated value to the user of the benefit achieved by performing the recommended action is based on at least one of: a monetary value associated with implementing the recommended action, a longevity of a benefit of implementing the recommended action, a difficulty of implementing the recommended action, and a feasibility of the user implementing the recommended action, based on the description of marketing and/or development resources of the organization of the user, wherein at least one of the monetary value, the longevity, the difficulty, and the feasibility is predicted by an ML model of the one or more ML models.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

It will be appreciated that the configurations and routines disclosed herein are exemplary in nature, and that these specific embodiments are not to be considered in a limiting sense, because numerous variations are possible. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

1. An analytics platform for providing automated digital marketing analysis, the platform comprising an automated insight generation system configured to:
collect digital marketing data from a plurality of data sources identified by a first user;
analyze the digital marketing data;
generate one or more actionable marketing insights based upon the analyzed digital marketing data;
generate a visual presentation of the one or more generated actionable marketing insights, the visual presentation comprising
at least one recommended action,
one or more elements of the analyzed digital marketing data providing support for the at least one recommended action,
a visualization summarizing the one or more elements, and
an estimated value to the user of performing the at least one recommended action; and
providing the visual presentation of the one or more generated actionable marketing insights to the user such that the user can access the visual presentation while the analytics platform is in an unlaunched state.

2. The analytics platform of claim 1, wherein the automated insight generation system is further configured to:
audit the plurality of data sources to determine a viability of the digital marketing data for generating the one or more actionable marketing insights, and in response to the audited digital marketing data not being viable, recommend to the user one or more adjustments to one or more configuration settings of the plurality of data sources;
extract the audited digital marketing data from the plurality of data sources;
transform the extracted digital marketing data, to increase a quality of the extracted digital marketing data for generating the actionable marketing insight; and
analyze the transformed digital marketing data.

3. The analytics platform of claim 2, wherein the auditing of the plurality of data sources further comprises:
checking a presence of digital marketing data in core functional fields of the plurality of data sources for sufficiency, consistency, and recency;
determining whether variables relied on by one or more rule-based systems and machine learning (ML) models of the analytics platform are present in the plurality of data sources;
scanning a website domain of the plurality of data sources for onsite technologies; and
combining audits of different data sources of the plurality of data sources to determine whether the different data sources include data this is reliable and sufficient across an expected set of analyses to perform.

4. The analytics platform of claim 3, wherein the combining of the audits of different data sources of the plurality of data sources further comprises:
performing a first audit of a first set of digital marketing data collected from a first data source; and
based on a result of the first audit, performing a second audit of a second set of digital marketing data collected from a second data source.

5. The analytics platform of claim 2, wherein the transforming of the extracted digital marketing data includes:
removing case sensitivity and common punctuation differences in the digital marketing data;
removing query strings in web addresses of the digital marketing data;
applying one or more custom algorithms specific to a data source of the plurality of data sources to the digital marketing data, to correct for limitations and/or common mistakes made with respect to marketing campaigns and ensure proper attribution;
normalizing the digital marketing data; and
merging digital marketing data from two or more data sources of the plurality of data sources.

6. The analytics platform of claim 2, wherein the automated insight generation system is further configured to audit, extract, and transform the digital marketing data a plurality of times during performing a plurality of analyses of the digital marketing data.

7. The analytics platform of claim 1, wherein the automated insight generation system is further configured to select one or more analyses to perform on the digital marketing data from a set of available analyses based on information provided by the user, the information provided by the user including:
a role of the user at a company of the user;
a primary goal of the user;
one or more secondary goals of the user;
information for accessing one or more data sources of the plurality of data sources.

8. The analytics platform of claim 1, wherein the automated insight generation system is further configured to:
perform a first analysis of a first set of digital marketing data collected from a first data source of the plurality of data sources, to generate a first result;
based on the first result, perform a second analysis of a second set of digital marketing data collected from a second data source to generate a second result; and
generate the one or more actionable marketing insights based on the second result.

9. The analytics platform of claim 1, wherein the estimated value is generated based on at least two of:
an estimated monetary value associated with implementing the recommended action;
an estimated longevity of a benefit of implementing the recommended action;
an estimated difficulty of implementing the recommended action; and
an estimated feasibility of the user implementing the recommended action, based on information regarding technological, labor, and/or other available resources specified by the user.

10. The analytics platform of claim 1, wherein the digital marketing data is not stored on the analytics platform after the visual presentation of the marketing insights is generated.

11. An analytics platform comprising a display device, the analytics platform being configured to display on the display device a menu of data-driven marketing insights generated by the analytics platform based on digital marketing data from a plurality of data sources, each data-driven marketing insight including marketing analysis results viewable on the display device; and additionally being configured to display on the display device, for each marketing insight, a visual presentation summarizing the marketing analysis results that can be reached directly from the menu; wherein the visual presentation includes a graphical depiction of the data-driven marketing insight including a limited selection of the marketing analysis results used to generate the data-driven marketing insight, each marketing analysis result in the limited selection being selectable to launch a display panel and enable at least the selected marketing analysis result and digital marketing data supporting the selected marketing analysis result to be seen within the display panel, and wherein the visual presentation is displayed on the display device while the analytics platform is in an unlaunched state.

12. The analytics platform of claim 11, wherein a data-driven marketing insight is personalized for a user of the analytics platform, based on information provided to the analytics platform during an automated online interview of the user conducted via a GUI of the analytics platform.

13. The analytics platform of claim 12, wherein the data-driven marketing insight includes a score indicating an estimated value to the user of implementing the data-driven marketing insight.

14. The analytics platform of claim 11, wherein generating the data-driven marketing insight based on the digital marketing data from the plurality of data sources further comprises:
auditing the plurality of data sources for a sufficiency, a consistency, and a recency of the digital marketing data;
in response to the digital marketing data not being sufficient, consistent, or sufficiently recent, generating a recommendation for adjusting one or more configuration parameters of one or more data sources of the plurality of data sources; and
in response to the digital marketing data being sufficient, consistent, and sufficiently recent, performing a first analysis of data from a first data source of the plurality of data sources, and using a result of the first analysis in a second analysis of data from a second data source to generate the data-driven marketing insight.

15. A method for an analytics platform, the method comprising:
collecting digital marketing data from a plurality of data sources specified by a user of the analytics platform;
analyzing the digital marketing data collected from the plurality of data sources using one or more machine learning (ML) models of the analytics platform;
based on the analyzed data, generating a visual presentation of an actionable marketing insight, the actionable marketing insight including at least a recommended action to perform to achieve a benefit, a summary of a portion of the analyzed data that supports the recommended action, the summary selectable to view the portion of the analyzed data, and an estimated value to the user of the benefit achieved by performing the recommended action;
wherein the visual presentation is not displayed in a dashboard of the analytics platform, and the visual presentation is viewable on a computing device of the user, while the analytics platform is in an unlaunched state.

16. The method of claim 15, wherein the analyzing of the digital marketing data collected from the plurality of data sources further comprises:
performing a first analysis of a first set of digital marketing data collected from a first data source of the plurality of data sources, to generate a first result;
based on the first result, performing a second analysis of a second set of digital marketing data collected from a second data source, to generate a second result; and
generating the actionable marketing insight based on the second result.

17. The method of claim 15, wherein the analyzing of the digital marketing data further comprises, prior to analyzing the digital marketing data:
reviewing a presence of digital marketing data in core functional fields of the plurality of data sources for sufficiency, consistency, and recency;
determining whether variables relied on by one or more rule-based systems and/or machine learning (ML) models of the analytics platform are present in the plurality of data sources;
scanning a website domain of the plurality of data sources for onsite technologies and/or capabilities; and
transforming the digital marketing data to increase a quality of the digital marketing data for generating the actionable marketing insight.

18. The method of claim 17, wherein the transforming of the digital marketing data further comprises:
checking for case sensitivity and common punctuation differences in the digital marketing data, and in response to detecting the case sensitivity and common punctuation differences, removing the case sensitivity and common punctuation differences from the digital marketing data;
checking for query strings in web addresses of the digital marketing data, and in response to detecting one or more query strings in the web addresses of the digital marketing data, removing the one or more query strings from the web addresses of the digital marketing data;
checking for limitations and/or common mistakes made with respect to a configuration of a marketing campaign, and in response to detecting the limitations and/or common mistakes, applying one or more custom algorithms to the digital marketing data to correct for the limitations and/or common mistakes;
checking for digital marketing data that would benefit from normalization, and in response to detecting digital marketing data that would benefit from the normalization, normalizing the digital marketing data; and
merging digital marketing data from two or more data sources of the plurality of data sources.

19. The method of claim 15, wherein analyzing the digital marketing data collected from the plurality of data sources and generating the actionable marketing insight further comprises:
receiving information from the user via a graphical user interface (GUI) of the analytics platform, the information including at least one of a job role of the user, a marketing goal of the user, and a description of marketing and/or development resources of an organization of the user;
based on the received information, selecting one or more analyses to perform on the digital marketing data, out of a total number of available analyses;
performing the selected analyses on the digital marketing data to generate a result; and
generating the actionable marketing insight based on the result.

20. The method of claim 19, wherein the estimated value to the user of the benefit achieved by performing the recommended action is based on at least one of:
a monetary value associated with implementing the recommended action;
a longevity of a benefit of implementing the recommended action;
a difficulty of implementing the recommended action; and
a feasibility of the user implementing the recommended action, based on the description of marketing and/or development resources of the organization of the user;
wherein at least one of the monetary value, the longevity, the difficulty, and the feasibility is predicted by an ML model of the one or more ML models.
